(19) United States
(12) Patent Application Publication
(10) Pub. No.: US 2007/0055964 A1
(43) Pub. Date: Mar. 8, 2007

(54) System and method for synthesizing object-oriented high-level code into browser-side javascript

(75) Inventors: Aram Mirkazemi, Lindisfame (AU); Shahram Besharati, Kingston Beach (AU)

Correspondence Address: William C. Milks, III;RUSSO & HALE LLP, 401 Florence Street, Palo Alto, CA, 94301, US

(73) Assignee: Morfik Technology Pty. Ltd.

(21) Appl. No.: 11/516,104

(22) Filed: Sep. 5, 2006

Related U.S. Application Data
(60) Provisional application No. 60/714,285, filed on Sep. 6, 2005.

(51) Int. Cl. G06F 9/45; G06F 9/44

(52) U.S. Cl. 717/140; 717/118; 717/115

(57) ABSTRACT

A system and method are provided to enable developers of web sites and software applications to code in an object-oriented high-level language that is compiled into a browser-side JavaScript which can be natively interpreted by a browser. This enables developers to program in a high-level language of choice to create browser-side web applications, instead of directly using the target lower-level language JavaScript.

### CROSS-REFERENCE TO RELATED APPLICATION

This application relates to U.S. Provisional Patent Application No. 60/714,285 filed on Sep. 6, 2005 entitled SYSTEM AND METHOD FOR SYNTHESIZING OBJECT-ORIENTED CODE INTO BROWSER-SIDE JAVASCRIPT.

### BACKGROUND OF THE INVENTION

1. Field of the Invention

The present invention relates generally to a system and method for object-oriented computer programming and, more particularly, to a system and method to enable a computer programmer to code in an object-oriented high-level programming language. In accordance with various embodiments of the present invention, a system and method are provided to enable developers of web sites and software applications, especially those that are Asynchronous JavaScript and XML (AJAX) driven, to code in an object-oriented high-level language that is compiled into a browser-side JavaScript which can be natively interpreted by a browser. The various embodiments of the present invention allow developers to use a high-level language of choice, preferably, an object-oriented language, and have it compiled directly and seamlessly to JavaScript.

2. Description of the Known Art

Previously, there have only been three ways that a programmer could develop complex application logic for web applications (sometimes referred to as Rich Internet Applications):
1. Perform all application logic on the server. In this manner, the entire state of the web application would be sent to the server, even to do the most basic of tasks, and then the entire state would be sent back to the client. All current server-side technologies are based on scripting languages. The most common languages are ASP, ColdFusion, JSP, PHP, Perl, Python, and Ruby.
2. Write the applications in Java or Flash/Shockwave. Although this allows the development of web applications using sophisticated languages, including object-oriented languages such as Java, the web applications do not run natively in the browser, and treat the browser merely as a dumb client that hosts a plug-in or virtual machine.
3. Write client-side JavaScript. JavaScript suffers from the disadvantage that it is not a compiled language, and further that it is not a fully object-oriented language.

The first two of these three web development approaches have dominated, primarily due to the backing by software vendors including Microsoft Corp., Macromedia, IBM Corp., and Sun Microsystems. However, especially with the rise of AJAX and its associated technologies, along with high-profile web applications such as Google Gmail and Google Maps, the desire to develop web applications that possess sophisticated client-side logic is becoming increasingly popular. This has resulted in a very real problem: the only way to develop native client-side logic is to utilize JavaScript, but it is very difficult to write large-scale projects purely in JavaScript.

By way of background, JavaScript is one of the more popular, if not the most popular, language used to program functionality into web browsers. Originally developed in 1995, “JavaScript is the name of Netscape Communications Corporation's implementation of ECMAScript, a scripting programming language based on the concept of prototypes. The language is best known for its use in websites, but is also used to enable scripting access to objects embedded in other applications . . . ECMAScript, in simple terms, is a standardized version of JavaScript.” See, http://en.wikipedia.org/wiki/JavaScript. JavaScript is not useful as a standalone language, but is designed for easy embedding in other products and applications, such as web browsers. Inside a host environment, JavaScript can be connected to the objects of its environment to provide programmatic control over them.

While JavaScript was originally created to run on a browser, the term “client-side JavaScript” was coined by Netscape. Since the advent of Netscape's Enterprise Server v2.0 in 1996, the language is no longer limited to just the client-side, because “server-side JavaScript” is also available.

Considered in more detail, “core JavaScript” contains a core set of objects, such as Array, Date, and Math, and a core set of language elements, such as operators, control structures, and statements. Core JavaScript can be extended for a variety of purposes by supplementing it with additional objects. For example, client-side JavaScript extends the core language by supplying objects to control a browser (Navigator or another web browser) and its Document Object Model (DOM). For example, client-side extensions allow an application to place elements on an HTML form and respond to user events, such as mouse clicks, form input, and page navigation. However, corporations, such as Adobe, are now using client-side JavaScript in their PDF documents, and, therefore, the term “browser-side JavaScript” is used to refer to the client-side JavaScript specifically designed to run in the web browser. Server-side JavaScript extends the core language by supplying objects relevant to running JavaScript on a server. For example, server-side extensions allow an application to communicate with a relational database, provide continuity of information from one invocation to another of the application, or perform file manipulations on a server. See, FIG. 1.

The ubiquity of browser-side JavaScript due to the ever-growing presence of the web creates a significant problem for most professional programmers, namely, JavaScript is inherently less sophisticated than other programming languages such as C++that are standard in the professional software development area. The result is that most web sites only consist of small amounts of code scattered throughout the web pages, rather than large scale amounts of code that are commonly present in software applications. This is a direct result of two limitations of JavaScript: first and foremost is that it is an interpreted language rather than a compiled language, and second is that it is object-based/prototype-based, rather than truly object-oriented.

Furthermore, there are currently very few, if any, professional-grade visual programming environments for programming JavaScript interactions on the client side. Like virtually all interpreted languages, JavaScript gains most of its meaning and practicality in the context of a host program (e.g., the browser), and associated input and output processes to such a host. Therefore, software that takes code and outputs core JavaScript, although possibly valuable from a philosophical or academic point of view, is of little practical value because it could only run in an extremely isolated environment.

Considered in more detail, known programming techniques typically fall into three categories.
1. Existing visual programming environments that include a compiler that accepts object-oriented code. This category includes products such as Microsoft's Visual Basic, Borland's Visual Class Library, and others. However, all of these compile to an executable. They do not compile to JavaScript, nor to any language that can be naturally interpreted by the browser.
2. Compilers that accept object-oriented code and convert the code to an interpreted language. Known approaches typically fall into three categories.
   1. Compilers whose target language is an interpreted language, but not JavaScript:
   S2: S2 is an object-oriented language and compiler that compiles to Perl. The compiler compiles an object-oriented language into an interpreted language (Perl) for the server-side of web applications. As described by Wikipedia.com (http://en.wikipedia.org/wiki/S2_programming_language):
      “S2 (Style System 2) is an object-oriented programming language developed in the late 1990s by Brad Fitzpatrick, Martin ‘Mart’ Atkins, and others for the picture-hosting website code FotoBilder as well as the online journalling service LiveJournal in order to allow users full control over the appearance of their pages. S2 source code is compiled into Perl, which the webserver can then execute directly for individual web page requests.
      “The S2 system is, at its heart, completely general and can be used for almost any web application.” See, also, their official site (http://www.livejournal.com/doc/s2/index.html):
         “S2 is a generic style system which web applications can use to give both ordinary users and programmers extreme control over the look of their content . . .”
         “The core of S2 is actually a programming language, with syntax and semantics resembling Perl/C++/Java/etc. People who do know how to program will be able to do anything they want, including make styles which all their non-geek friends will be able to use, since the styles are capable of reflecting all their options, which the graphical wizard lets them tweak . . .”
         “Internally, S2 code is compiled into a lower level language and run directly when the page is loaded, . . . no parsing is necessary at run time. Also, S2 outputs directly to the client . . . since S2 doesn't need to do tons of templating replacements at the end . . .”
   S2 is currently in widespread use by users of www.LiveJoumal.com and www.FotoBuilder.com. This approach has various limitations including a) it does not compile code for the client-side of web applications; b) it does not compile into JavaScript; and c) it does not offer developers a visual programming environment. Whenever the phrase “object-oriented” is used to describe this approach, it is used in a very loose or general sense. All examples, without exception, show a complete lack of encapsulation. Furthermore, there is no mention of encapsulation. Also, it is not clear if polymorphism is even possible, or if inheritance is class-based or merely prototype-based.
PdB: PdB is an optimizing compiler to compile ANSI-C (like) code into Adobe compatible PostScript. ANSI-C is not object-oriented. PdB does not compile into JavaScript/ECMAScript. Nor does PdB compile code for the client-side of web applications.
LispScript: LispScript allows developers to write in Lisp-like code, and it outputs it to PostScript. This approach only converts Lisp to Postscript.
   2. Compilers whose target language is core JavaScript:
S2 derivative: One of the key developers of S2 made some ad hoc modifications and extensions to S2 to create a “proof of concept” compiler that took S2 code and compiled it into core JavaScript instead of the built-in Perl. He, himself, states “the current implementation is alpha and has many rough edges.”
   As stated at the S2 Developer forum
(http://www.livejournal.com/community/lj_dev/600713.html):
   “For some reason, the perspective of having S2 code compile to javascript seemed strangely appealing to me, so I wrote just that. It could be a usefull piece as part of a mechanism to allow end-users to have some sort of client-side scripting on their journal.”
   Note: The developer includes a few rough notes as well as some sample S2 code and the resulting core JavaScript code.
   Note: He does not offer a link for the readers of the thread to download the modified compiler.
Except on the day he announced it to a specialized S2 developer's forum (Jan. 4, 2004), neither he, nor anyone else, has discussed this variation further.
   In any event, this approach has various limitations, namely, it is only a “proof of concept” and has not been developed to a stage that could be considered useful, and it only compiles from S2 to core JavaScript. The key feature that would make this useful, i.e., client-side JavaScript, is not present. The developer stated: “This would need some additional . . . hooks into the javascript event model before starting to be useful.” A compiler that outputs to core JavaScript, though valuable as an academic exercise, lacks commercial usefulness as the code must then run in an isolated system. The ability to output to client-side (or server-side) JavaScript, which allows it to interact with input and output mechanisms, is the key to making it a commercially viable product.
   3. Frameworks whose source language is a high-level language and presentation and interaction layer (graphical user interface (GUI)) is browser-based, but the logical layer resides on the server in the form of Java source code.
WebCream: WebCream is a tool for Java that provides automated web-enabling for GUI based Java applications and applets. It allows developers to implement a GUI front end using AWT and Swing, and at the same time automatically get HTML access to the application. This approach only creates a client-side GUI. It does not compile, translate, or convert Java code into client-side JavaScript. Furthermore, there is no support for the visual programming paradigm.
WebOnSwing: WebOnSwing provides a template engine that simplifies the integration of Java-based components and windows with HTML templates. This approach only creates a client-side GUI. It does not compile, translate, or convert Java code into client-side JavaScript. Furthermore, there is no support for the visual programming paradigm.
   4. Techniques whose objective is to port non-web applications.

As noted above, the problems associated with the creation of web applications in JavaScript are well-known. To partially address these problems, several authors have suggested that Java code and associated GUI Java Swing objects be ported to JavaScript. By “ported” it is meant that code that is designed to be executed in an original environment is transformed into new code to be executed in a new environment. Examples of authors who suggest the porting of Java code to JavaScript include Kenichi Takagi in “Transparently Porting Swing Applications to Web Applications,” Technical Reports SFSU-CS-TR-04.22, SFSU Computer Science Department, May 17, 2004, Arno Puder in “Extending Desktop Applications to the Web,” SFSU Computer Science Department, and Professor Puder and others associated with the XML11 initiative at SFSU.

While the porting of existing applications to JavaScript has the desirable result of not having to program web applications directly in JavaScript, it does suffer from certain limitations and drawbacks. For example, a ported application may not be as well configured for a new environment as it was for its original environment. Also, the ported application may not perform as well in the new environment. Furthermore, modifications and debugging of ported applications tend to be difficult.
3. Visual programming environments for client-side JavaScript. The only known well-featured environment for developing JavaScript applications is a product that requires the developer to program in JavaScript referred to as Netscape's Visual JavaScript Builder. In April 1997, Netscape released a beta version of “Netscape Visual JavaScript Builder” (“JSBuilder”) that was available only to developers. Offered as part of an enterprise web solution that involved multiple technologies, JSBuilder offered developers a visual programming environment, thus easing the burden of writing client-side JavaScript. It also offered developers a JavaScript code editor and a light run-time library of pure JavaScript functions, in order to facilitate faster JavaScript programming.
   As described at http://www.pmewswire.com/cgi-bin/stories.pl?ACCT=104&STORY=/www/story/83534&EDATE=
      “. . . visual programming tool that lets enterprise developers rapidly build Crossware applications—or applications that run across Intranets and Extranets—without writing software code. Netscape Visual . . . is a new class of tool written entirely in Java that makes it easy to leverage both client and server-side functionality and the network services provided by Netscape SuiteSpot server software to build applications. Developers simply use the point-and-click user interface in Netscape Visual JavaScript to drag and drop existing software components—written in Java, JavaScript or HTML—on to Web pages to build dynamic applications that are platform independent . . . Developers start by creating a Web page in the HTML Page Builder, and then, simply add application functionality by selecting from the Component Palette—a rich array of pre-built HTML form elements, JavaScript components and JavaBeans . . . . Using the Inspector and Connection Builder features, developers can customize the application behavior of these components—without writing code—by visually setting properties and making connections between them. When finished, developers check their completed applications with the JavaScript debugger included in Visual JavaScript and rapidly deploy them through simple one-button publishing to a staging area or Web server.”
         Other relevant links are http://wp.netscape.com/enterprise/vjs/datasheet.html and http://www.jalix.org/ressources/internet/dhtml/—netscape/devguide/vjs.htm.
   This approach also has various limitations. First, developers still needed to code in pure JavaScript. Second, JSBuilder was in beta and only available to developers until the entire product and all related support was officially discontinued in 1999.

Therefore, the known web application programming approaches and techniques have numerous limitations to which the present invention is directed as a solution. The various embodiments of the present invention have as an objective to allow software developers the opportunity to write web applications using their existing skills and knowledge. Prior to the present invention, they could not do so. There was no technology that allowed web application developers to program web applications that were native to the browser i) in an object-oriented language or ii) in language that was statically and/or strongly typed. Furthermore, no compiler existed that compiled to browser-side JavaScript. The various embodiments of the present invention provide many advantages over conventional programming methodologies.

### SUMMARY OF THE INVENTION

The various embodiments of the system and method in accordance with the present invention provide a developer with the power of programming in a fully object-oriented high-level language that is then compiled into a browser-side JavaScript compliant language which can in turn be natively interpreted by browsers. In contrast to a library of pre-written functions and procedures, the embodiments of the present invention provide an entire platform comprising objects that the developer can, through object-oriented programming, descend from. Abstract objects which have already been defined include the basic input and output mechanisms to the browser and allow the developer to create very sophisticated and scaleable code. At run-time, this code that the developer has written, as well as any necessary automatically generated code, forms what has become known as the client-side engine consisting of a set of JavaScript files that remains throughout the entire duration of a user's web experience.

Accordingly, the various embodiments of the system and method in accordance with the present invention enable software developers to create web sites and applications that are native to the browser, using a methodology similar to that of developing traditional desktop software. This methodology rests upon using a traditional high-level programming language that is then compiled into a lower-level language, in this case JavaScript. This allows developers to leverage the features inherent in the higher-level language with their existing knowledge, skills, and programming methodologies in order to develop large-scale and complex web applications in an efficient manner. This is in direct contrast to the known techniques of developing web applications, which are either through server-centric approaches, coding in interpreted scripting languages that are generally slower and more prone to error, or by utilizing mechanisms that require the user to download specific plug-ins or virtual machines.

The various embodiments of the system and method in accordance with the present invention enable developers to:
1. create web sites and applications that run natively in a browser;
2. by writing in a high-level language;
3. that is then compiled;
4. into a lower-level language, specifically, browser-side JavaScript.
   The developer preferably programs in a visual programming environment.

Accordingly, the currently preferred embodiment of the system and method in accordance with the present invention synthesizes the client-side code from a fully object-oriented high-level language such as written in a Basic- or Pascal-like syntax, and compiles it into browser-side JavaScript. This is an extension of the core JavaScript that includes objects to control a browser and its Document Object Model. Alternative preferred embodiments of the present invention include options for the developer to program using other high-level language such as C# or Java-like syntax.

The various embodiments of the present invention allow developers to create sophisticated client-side logic as part of their web applications. In the field of web development, the vast majority of web applications prior to the present invention were created by utilizing the power of the server aspect of web applications or by requiring the use of a non-native structure in the browser such as a plug-in or virtual machine. Those web applications that did not pursue this path had their client-side logic written directly in JavaScript. Furthermore, in the field of software development, the traditional compilers would take a high-level language and compile it to a primitive language such as byte-code, p-code, or assembly language. It was not considered useful or relevant, either at an academic level or commercial level, to compile a high-level language into an interpreted language for the browser. That is, prior to the present invention there were no compilers that took a high-level language and compiled it to browser-side JavaScript.

The preferred embodiments of the present invention offer a solution to programming web applications by allowing developers to program in an object-oriented high-level language, and syntax of choice, and compiling all relevant application logic into browser-side JavaScript. In this manner, JavaScript is abstracted away from the developer, and he or she has to know JavaScript only as much as he or she would have needed to know assembly language or byte-code when developing desktop applications. Not only does this free the developer from issues such as cross-browser implementations and incompatibilities, it allows the developer to fully utilize his or her existing knowledge, skill, and methodologies to harness the beneficial features intrinsic to programming in a high-level language.

The foregoing and other objects, features, and advantages of the present invention will become more readily apparent from the following detailed description of various embodiments, which proceeds with reference to the accompanying drawing.

### BRIEF DESCRIPTION OF THE DRAWING

The various embodiments of the present invention will be described in conjunction with the accompanying figures of the drawing to facilitate an understanding of the present invention. In the figures, like reference numerals refer to like elements. In the drawing:

FIG. 1 shows a block diagram of the project manager for the conventional visual programming environment (VPE);

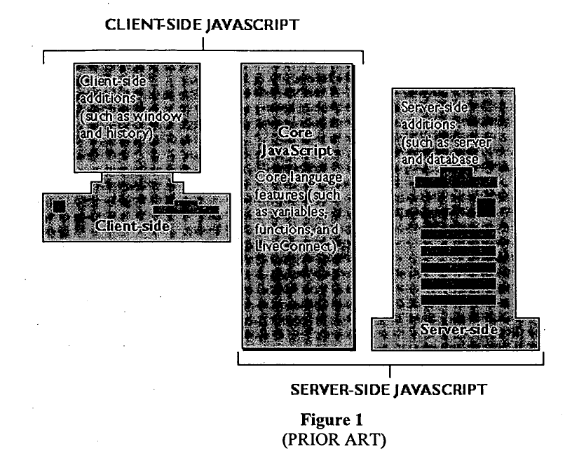

FIG. 2 is a block diagram illustrating an example of a system for compiling an object-oriented high-level language to browser-side JavaScript in accordance with one embodiment of the present invention;

FIG. 3 illustrates a screen associated with the project manager for the VPE preferably incorporated into the system shown in FIG. 2;

FIG. 4 illustrates a basic event handling screen associated with Forms in the VPE;

FIG. 5 illustrates an event handling screen for selecting the control that is to be associated with an event;

FIG. 6 illustrates an event handling screen showing an example of a user-defined function called ‘Recalculate’;

FIG. 7 illustrates a screen showing how to define an event that alters the formatting (text, font size, and font color) of a control;

FIG. 8 illustrates a screen showing declarations automatically generated in conjunction with the user-defined function called ‘Recalculate’;

FIGS. 9-12 illustrate that the VPE also allows for the creation and modification of database-related entities which can easily be incorporated into the Forms shown in FIG. 4;

FIGS. 13 and 14 are screens indicating how the Forms appear to a user in the browser at run-time;

FIG. 15 shows a plurality of client-side machines and server-side machines coupled to the Internet;

FIG. 16 is a dataflow diagram which depicts a process by which source files may be converted into client-side JavaScript and server-side executable code;

FIG. 17 illustrates a process by which source files are converted into browser-side code and server-side binary code;

FIG. 18 illustrates the operation of the parser shown FIG. 16;

FIG. 19 illustrates an exemplary portion of the semantic map shown in FIG. 16;

FIG. 20 depicts the process by which the semantic map is emitted into browser-side code and intermediate code by the emitter shown in FIG. 16;

FIG. 21 shows the process of emitting to browser-side code shown in FIG. 20;

FIG. 22 depicts a run-time arrangement of various routines which support remote procedure calls; and

FIGS. 23 and 24 illustrate an exemplary arrangement of prototypes that is disposed to mimic class-based behavior.

### DETAILED DESCRIPTION OF THE PREFERRED EMBODIMENTS

The present invention is particularly applicable to a computer-implemented software-based system and method to code web sites and software applications in an object-oriented high-level language compiled into a browser-side JavaScript which can be natively interpreted by a browser, and it is in this context that the various embodiments of the present invention will be described. The following describes all the standard browser-side structures that can be created and/or accessed. The examples included are based on a preferred embodiment which includes a visual programming environment (VPE). Finally, all the standard object-oriented programming structures that can be used by developers are described.

In this specification, the word “synthesizer” and its derivatives are used in the context of the “combining of separate elements or substances to form a coherent whole.” [Source: The American Heritage® Dictionary of the English Language, Fourth Edition]. Thus, in this specification “synthesis” means that a VPE is preferably used in connection with programming in an object-oriented high-level language that is processed by a compiler to produce browser-side JavaScript. The term “compiler” and its derivatives are used in a general sense to mean “a computer program that translates a series of instructions written in one computer language (called the source language) into a resulting output in another computer language (also called the object or target language).” [Source: http://en.wikipedia.org/wiki/Compiler]. However, one should not associate the term with the limited, but traditional, assumption that compilers must always convert to byte-code. In this specification, the meaning of the term “compiler” includes a transcoder that parses a programming language, performs semantic mapping, and emits an interpreted language, more particularly, browser-side JavaScript. Thus, a compiled language is any language or implementation of a language that utilizes a compiler to transform code from one language to another. Traditionally, this is done at design-time, but with the advent of just-in-time (JIT) compilers, it is often done in a two-stage process, first translating from a high-level language into byte-code at design-time, and then byte-code to the target code at run-time. Compiled languages thus include, for example, Ada, C, C++, COBOL, ColdFusion, Common Lisp, Delphi, Fortran, SmallTalk, and Visual Basic, as well as JIT-compiled languages including C#, Java, and Visual Basic.NET.

Also, in this specification, “high-level language” includes those languages that are object-oriented, compiled, and statically and preferably strongly typed. The following meaning applies to “statically and strongly typed”: “The process of verifying and enforcing the constraints of types—type checking—may occur either at compile-time (a static check) or run-time (a dynamic check). Static type-checking [i.e., statically typed] becomes a primary task of the semantic analysis carried out by a compiler. If a language enforces type rules strongly (that is, generally allowing only those automatic type conversions which do not lose information), one can refer to the process as strongly typed, if not, as weakly typed.” Source:

http://en.wikipedia.org/wiki/Type_system#Static_and_dynamic_typing.

In this context, “statically typed” languages include: Ada, C, C++, C#, Delphi, Fortran, Java, Haskell, Visual Basic, and Visual Basic.NET. Furthermore, in this context, “strongly typed” languages include: Ada, C#, Delphi, Fortran, Java, Haskell, Mathematica, Python, Ruby, SmallTalk, Visual Basic, and Visual Basic.NET.

Additionally, in this specification, “object-oriented” includes any language that allows for encapsulation, polymorphism, and class-based inheritance. Preferably, the encapsulation should be explicit. Classes provide stronger and more flexible abstractions than prototypes. A class can determine the pattern of members that each instance must have, control the creation of instances, and control both its usage and overriding interfaces. Accordingly, object-oriented languages include: ADA 95, C++, C#, Common Lisp, Delphi, Java, Modula2, Object Pascal, Perl 5, PHP, Python, Ruby, Simula, and SmallTalk, and do not include the prototype-based languages comprising Self and ECMAScript (including ActionScript, JavaScript, Jscript, and NewtonScript).

In the current and preferred embodiment, the developer fully utilizes a professional grade VPE, similar to that of Microsoft's Visual Basic or Borland's Delphi Visual Class Library, which offers developers rapid application development of graphical user interfaces, easy access to databases, and event-driven programming by modifying the attributes and event handlers of the controls provided by the VPE itself. In this specification, “visual programming” means the paradigm where there is a tight integration between the visual components and elements that make up the graphical user interface of the web application and the underlying code.

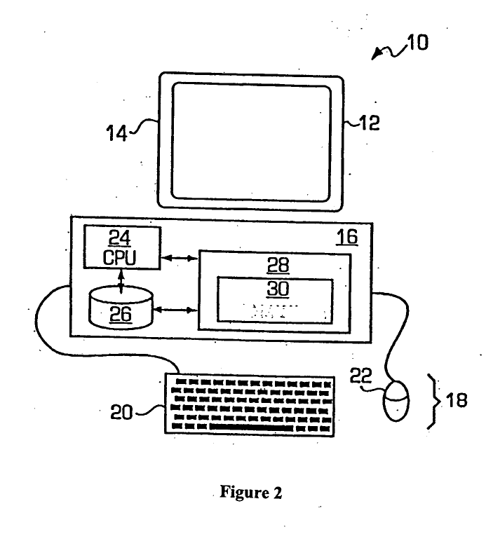

FIG. 2 is a block diagram illustrating an example of a system 10 for programming in an object-oriented high-level language and compiling to browser-side JavaScript in accordance with one embodiment of the present invention implemented on a personal computer 12. In particular, the personal computer 12 may include a display unit 14, which may be a cathode ray tube (CRT), a liquid crystal display, or the like; a processing unit 16; and one or more input/output devices 18 that permit a developer to interact with the software application being executed by the personal computer. In the illustrated example, the input/output devices 18 may include a keyboard 20 and a mouse 22, but may also include other peripheral devices, such as printers, scanners, and the like. The processing unit 16 may further include a central processing unit (CPU) 24, a persistent storage device 26, such as a hard disk, a tape drive, an optical disk system, a removable disk system, or the like, and a memory 28. The CPU 24 may control the persistent storage device 26 and memory 28. Typically, a software application may be permanently stored in the persistent storage device 26 and then may be loaded into the memory 28 when the software application is to be executed by the CPU 24. In the example shown, the memory 28 may contain a compiler 30 for translating an object-oriented high-level language to browser-side JavaScript. The compiler 30 may be implemented as one or more software modules that are executed by the CPU 24. The memory 28 also may preferably contain VPE software to provide a visual programming framework.

The currently preferred embodiment preferably synthesizes the client-side code within a VPE from a fully object-oriented high-level language that is written, for example, in a Basic- or Pascal-like syntax, and compiles it into browser-side JavaScript. This is an extension of the core JavaScript that includes objects to control a browser and its Document Object Model (DOM).

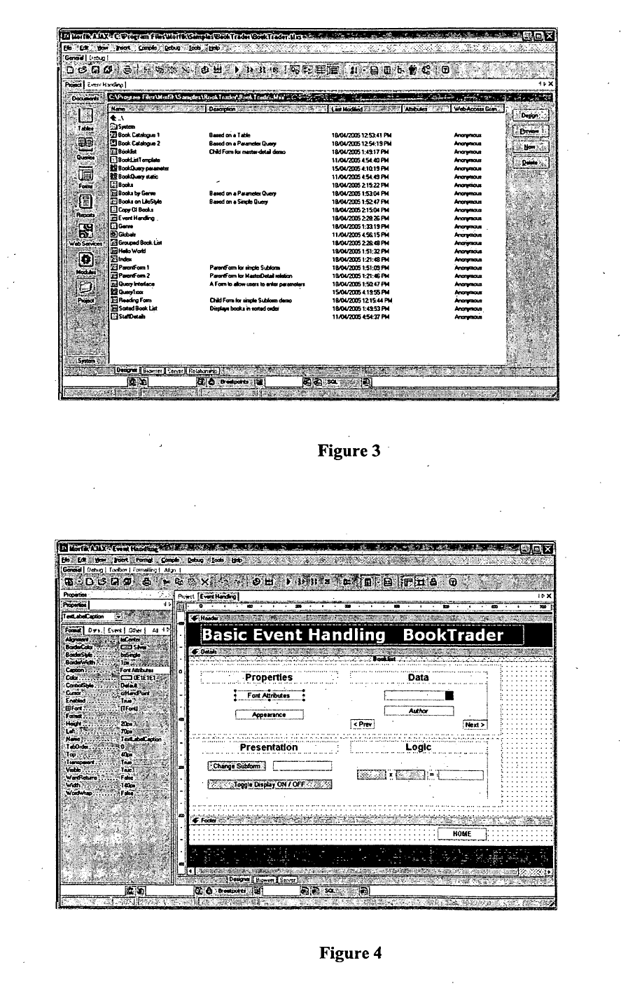

The key to browser-side JavaScript is enabling the developer to program the interactions with the browser. One of the most effective ways to program is via a VPE, otherwise known as an integrated development environment (IDE). FIG. 3 shows a screen for a preferred embodiment of a VPE. A project comprises a set of core objects: Forms, Reports, Queries, Tables, Web Services, and Modules. (The former three may be considered as visual objects because the developer builds them using visual components.) Note that a project may result in a web site, web application, or the like.

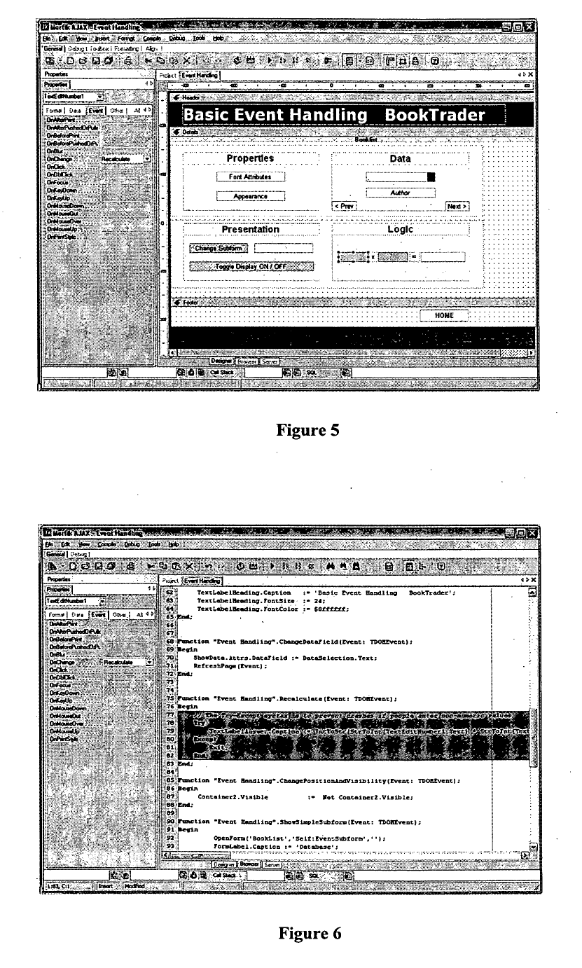

As shown in FIG. 4, the Forms are very similar both in presentation as well as functionality as one encounters with other professional VPEs, such as Microsoft's Visual Basic or Borland's Delphi. It consists of a canvas where control (components) are placed, as well as a property sheet (sometimes known as an Object inspector) which shows properties related to Formatting, data-binding, as well as events.

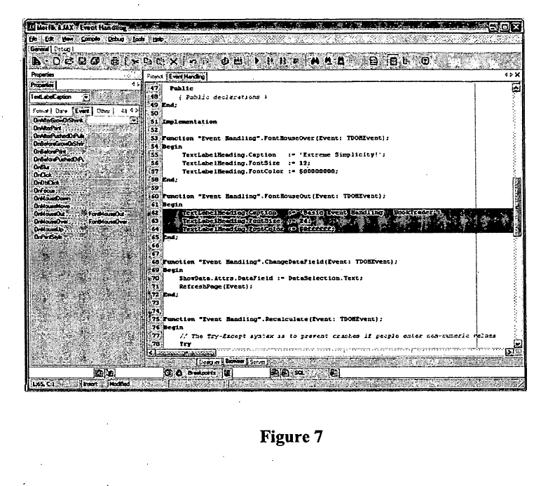

Referring to FIG. 5, event-handling, a key to developing quality browser-side JavaScript, is performed in a manner very similar to many professional VPEs. First, the developer selects the control that is to be associated with an event (in this case, a TextEdit control called ‘TextEditNumber1’). Then, he or she selects which browser event it is to be associated with. This property sheet will offer any pre-existing function/procedure that is compatible with an event for this control. The developer can either select one of these procedures or define a new one.

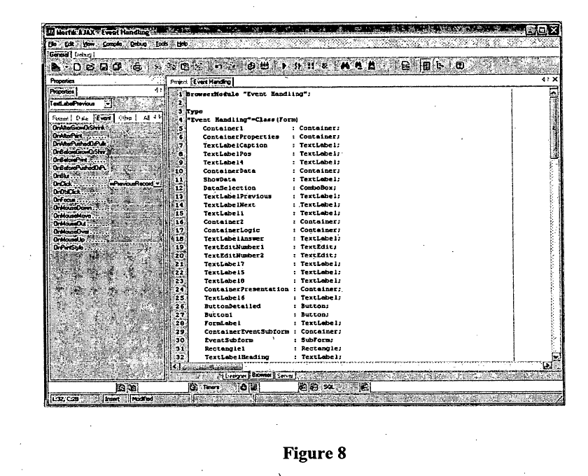

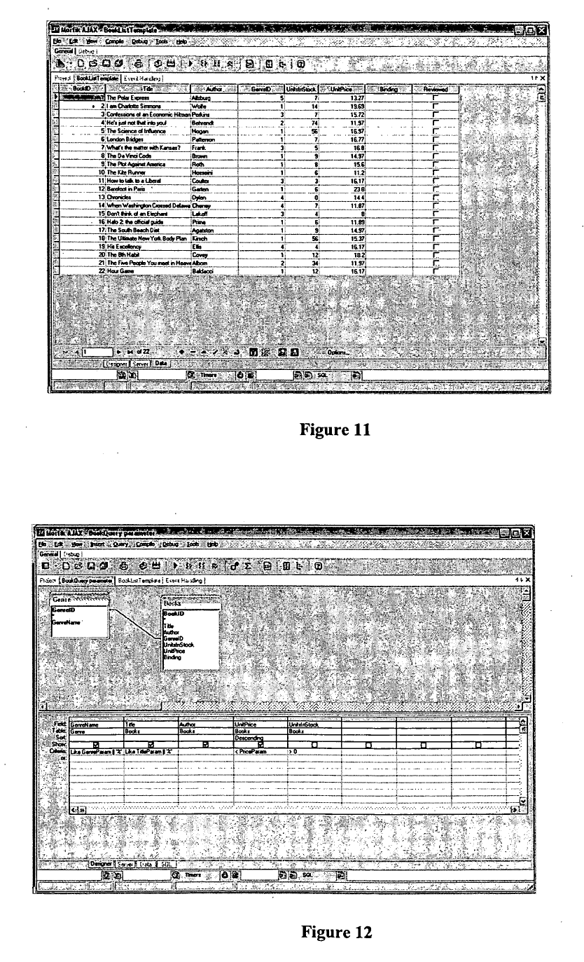

FIG. 6 shows an example of a user-defined function called ‘Recalculate’. The VPE automatically generates much of the code, including all necessary declarations (see also FIG. 8). One can then enter the desired code (in this case, lines 77-82 inclusive). Note that this code references other controls that are located in the Form (TextEditNumber2 and TextLabelAnswer).

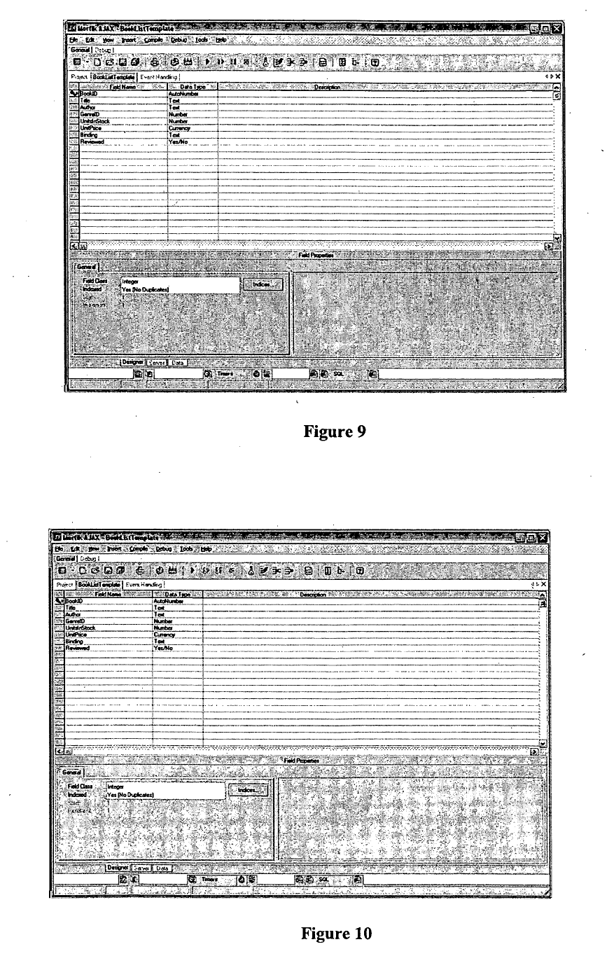

Likewise, a developer can alter properties of the DOM. For example, FIG. 7 illustrates how to define an event that alters the formatting (text, font size, and font color) of a control.

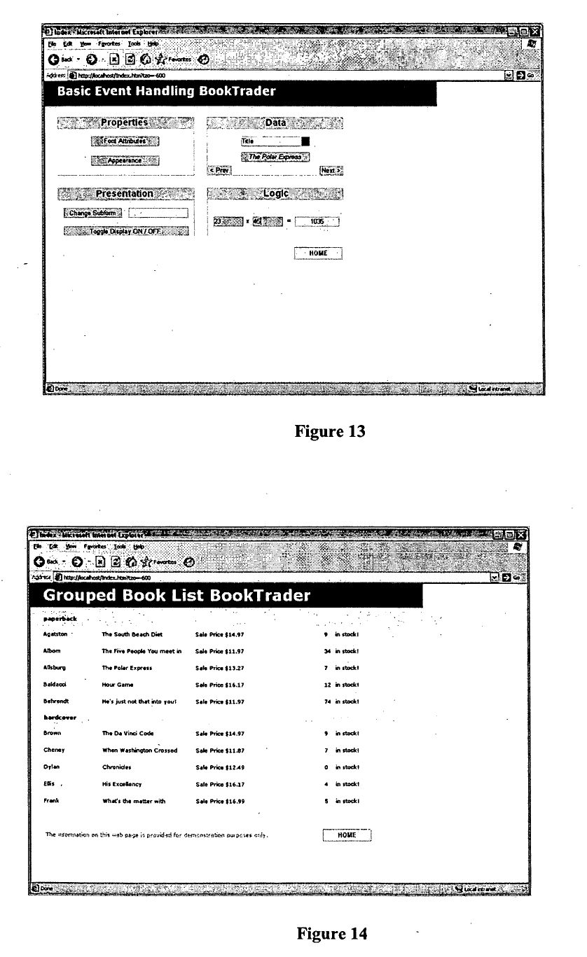

FIGS. 9-12 illustrate that the VPE also allows for the creation and modification of database-related entities which can easily be incorporated into Forms. See FIG. 4. This shows that one may use a browser input process (e.g., a mouse click) to trigger a variety of standard database processes.

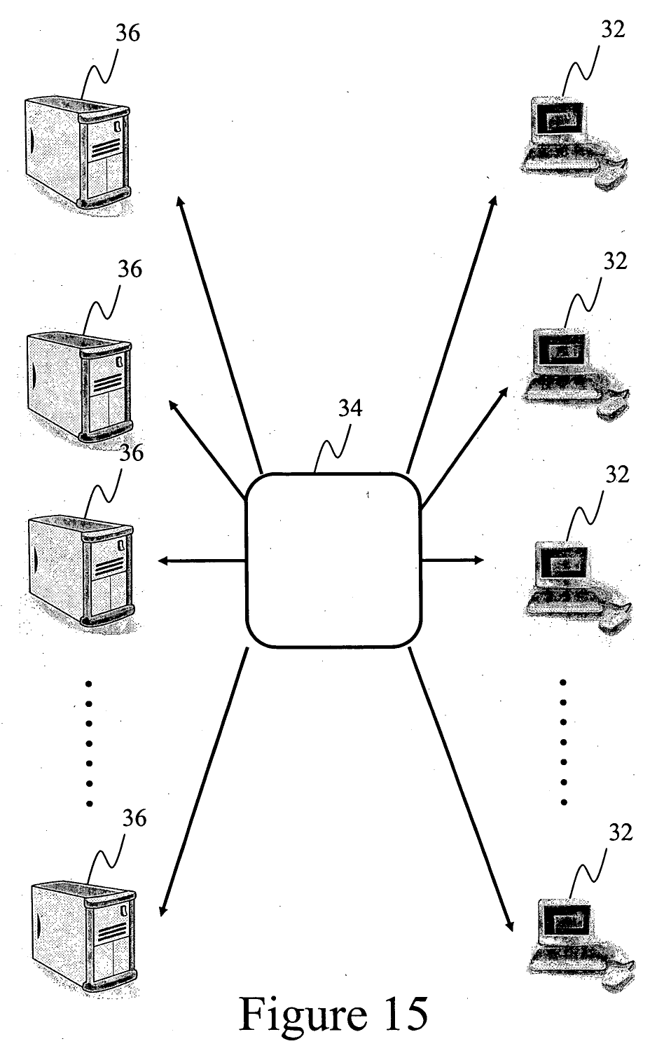

FIGS. 13 and 14 are screen shots that indicate how the Forms appear to the user in the browser at run-time. FIG. 13 corresponds to FIGS. 4-8 and FIG. 14 corresponds to FIGS. 9-12.

The various embodiments of the system and method in accordance with the present invention also compile the fully object-oriented high-level language or code to browser-side JavaScript. The term “object-oriented” is very widely used. Consequently, the fact that the various embodiments of the present invention allow developers to code in a fully object-oriented language may mean different things to persons skilled in the art. For example, JavaScript is often referred to as object-oriented. However, it may be more precise to call JavaScript “an object-based scripting language that is based on prototyping.” The purpose of this section is to describe what constitutes “an object-oriented language” by explicitly stating what the various embodiments of the present invention are capable of implementing.

Appendix 1 is a list of key functionalities that the system and method in accordance with the various embodiments of the present invention are capable of processing. The listed functionalities are ones that one would expect in a professional- or commercial-standard, object-oriented synthesizer or compiler.

All references in Appendix 1 in square brackets [.] refer to line numbers of the code. The number before the → symbol refers to the corresponding line in the original object-oriented code (the input), and the number(s) after the → symbol refer to an indication of the corresponding line numbers in the synthesized browser-side JavaScript (the output) using a preferred embodiment of the present invention. The descriptions of the features are terse as persons skilled in the art are very familiar with these concepts.

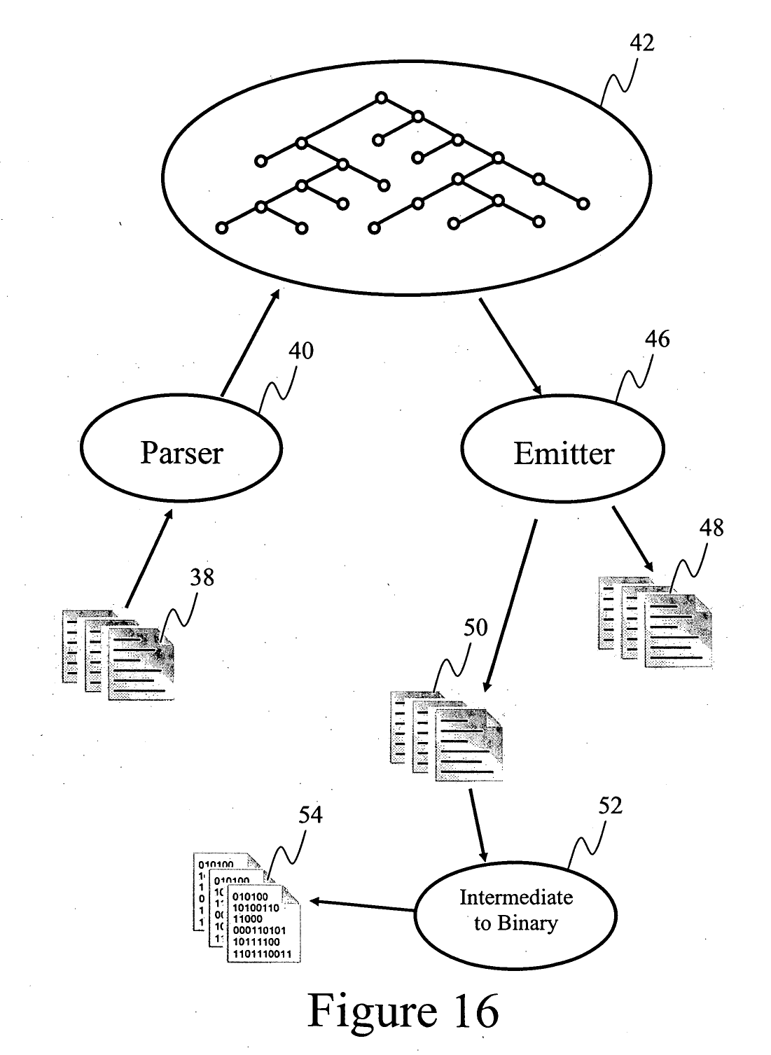

Further, note that the JavaScript file as listed will not run as a standalone JavaScript file. The system and method in accordance with various embodiments of the present invention take not only all user-defined code, but also all necessary inherited code, and compile the code into a set of JavaScript files. Most of these JavaScript files are synthesized from the run-time library that is built into the development platform to allow such features as object-oriented programming, and form the core of the browser-side JavaScript. The synthesized versions of user-defined code appear as separate files which are appended to the browser-side JavaScript engine. The process for compiling the code will now be described with reference to FIGS. 15-24.

Generally, FIG. 15 shows a plurality of client-side machines 32 coupled to the Internet 34. Also coupled to the Internet 34 is a plurality of server-side machines 36. In certain exemplary embodiments, the client-side machines 32 request web pages from the server-side machines 36 via the Internet 34. An exemplary web page consists of HTML code which in certain embodiments may also include JavaScript code. The JavaScript code is interpreted by a JavaScript interpreter which is embodied in the browser software running on the client-side machines 32. Typically, JavaScript code is embedded in an HTML document through the use of a tag.

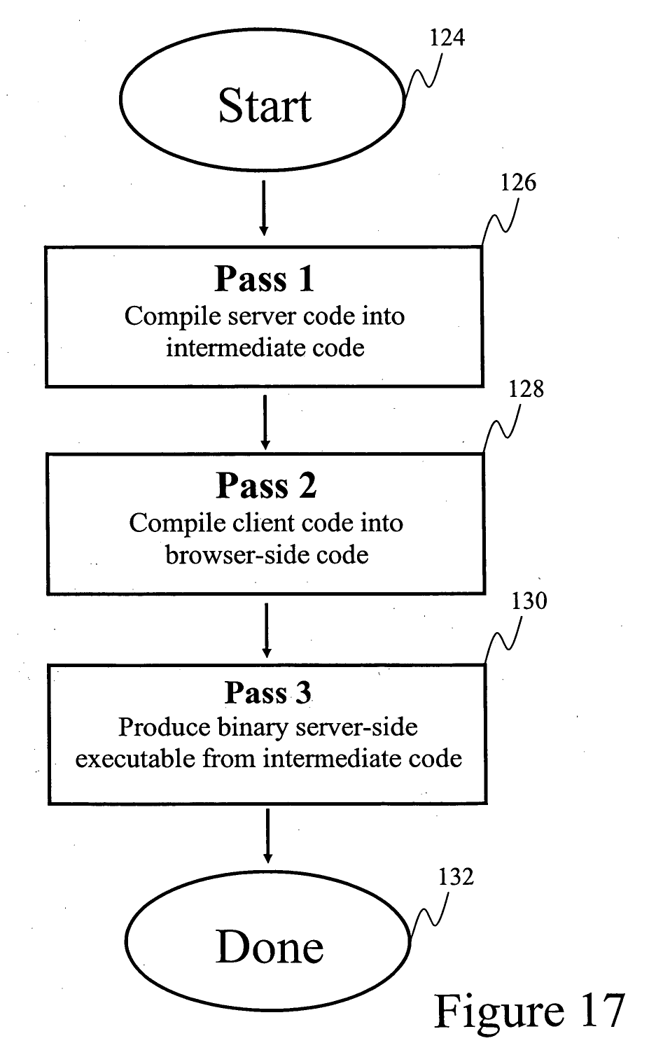

FIG. 16 illustrates is a dataflow diagram which depicts a process by which source files may be converted into browser-side JavaScript and server-side executable code. Source files 38 are read by a parser 40 which constructs a semantic map 42. The semantic map 42 is a structured representation of the information contained in the source files 38 and includes semantic information of the program embodied by the source files 38 and typically obtained by parsing the code through a semantic analyzer. It will be appreciated by persons skilled in the art that the term semantic tree may be used interchangeably with the term semantic map. In some embodiments, the semantic map 42 may contain all of the information contained in the source files 38. In certain embodiments, unneeded information such as white space or comments is removed in the process of generating the semantic map 42. One form of semantic map 42 is an abstract syntax tree which is a finite labeled directed tree where the internal nodes are labeled by operators and the leaf nodes represent the operands and node operators. The abstract syntax tree is an entity that contains semantic information and not just syntactical information.

Once the semantic map 42 has been generated by the parser 40, an emitter 46 produces browser-side code 48 and intermediate code 50. The browser-side code 48, in certain embodiments, includes JavaScript code which is to be loaded on to client-side machines 32 upon accessing a web page containing the appropriate HTML tag containing the JavaScript. The intermediate code 50 is, in one embodiment, high-level language code which embodies the server-side elements of the software to be executed in concert with the browser-side code 48. For example, if certain portions of the browser-side code 48 call for communication with code running on a server-side machine 36, then, a remote procedure call (RPC) is initiated on the client side and results in execution of a specific routine or method on the server-side machine 36. The intermediate code 50 is converted to binary executable code by intermediate to binary process 52 which reads intermediate code 50 and produces server-side binary code 54. Thus, the browser-side code 48 is executed on the client-machine 32, and server-side binary code 54 is executed on the server-side machine 36. The server-side binary code 54 includes various support routines to assist in the implementation of RPC, for example, as well as various other support utilities. The server-side binary code 54 also includes implementations of server-side routines declared in the source files 38. In one embodiment, the server-side binary code 54 is resident in a server-side machine 36 and is disposed to service a plurality of client-side machines 32. In another embodiment, the server-side binary code 54 is loaded into the memory of the server-side machine 36 only upon a request from the client-side machine 32 which necessitates its loading by, for example, calling one of the remote procedure calls. The server-side binary code 54 may run in a single process that services multiple client-side machines 32 or, alternatively, it may run in multiple processes each of which services a single client-side machine 32.

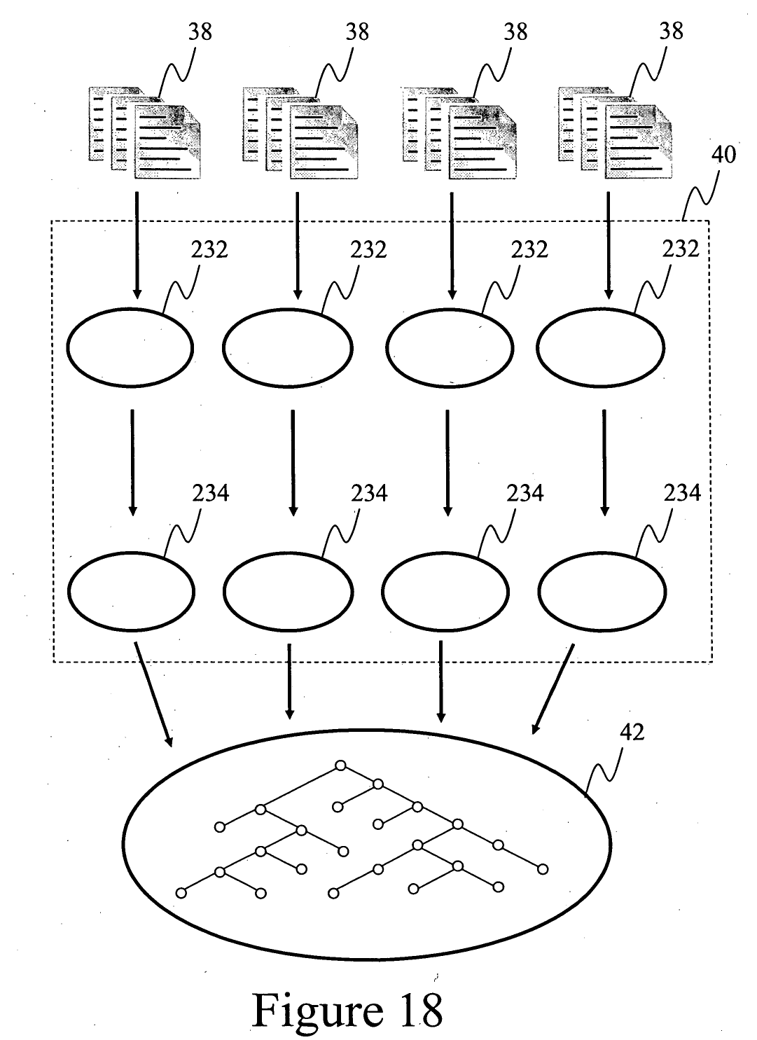

Referring now to FIG. 17, and with continuing references to FIGS. 15 and 16, a process is described by which the source files 38 are converted into browser-side code 48 and server-side binary code 54. The process begins in an operation 124 and continues in an operation 126 wherein a first pass over a given source file 38 parses the source file 38 and produces a semantic map 42. During this pass, the source files 38 are examined for any code which is to execute on the server side. Other codes, such as, for example, source code that is meant to execute on the client-side machine 32, is handled in a separate pass. In another embodiment, all of the code is parsed and produced in the semantic map 42 and, then, subsequent processes selectively process portions of the semantic map 42 pertaining to server-side code. The emitter 46 produces intermediate code 50 by walking over the semantic map 42 and producing high-level language source code representative of server-side constructs found in the semantic map 42. In one sense, the emitter 46 is reversing the operation of the parser 40, because it is producing a high-level language source file such as intermediate code 50 from the semantic map 42. Once the emitter 46 has produced its output, the operation 126 is completed.

Then, in an operation 128, a second pass reads the source files 38 and produces browser-side code 48. The operation begins with the parser 40 reading one or more source files 38 and producing a semantic map 42. Once the semantic map 42 has been constructed from the source file 38 by the parser 40, the emitter 46 walks over the various nodes of the semantic map 42 and produces browser-side code 48. The emitter 46 selectively ignores any portions of the semantic map 42 that are not relevant to this procedure. However, when the emitter 46 encounters server-side code in the semantic map 42, the server-side code is not ignored. Rather, in certain embodiments, a stub routine is emitted for each routine or method representing a server-side operation. The purpose of the stub routine is to provide an interface that is conveniently callable by any portion of the browser-side code 48. This provides the illusion that the server-side code is local. The developer may be aware that some code is executing on the server side, but he or she does not have to worry about the communications mechanism; he or she merely has to call the stub routine which does the work of communication with the server-side code. Once the emitter 46 has produced browser-side code 48 from the semantic map 42, the operation 128 is completed.

Then, in an operation 130, a third pass is made which produces binary server-side executable code 54 from the intermediate code 50. The operation of intermediate to binary process 52 is performed by a compiler for the high-level language in which the intermediate code 50 is written. The choice of language for the intermediate code 50 is one of preference and may be, for example, Java, C++, or Object Pascal. These examples are to be considered non-limiting. Upon completion of the operation 130, the operation is concluded in an operation 132.

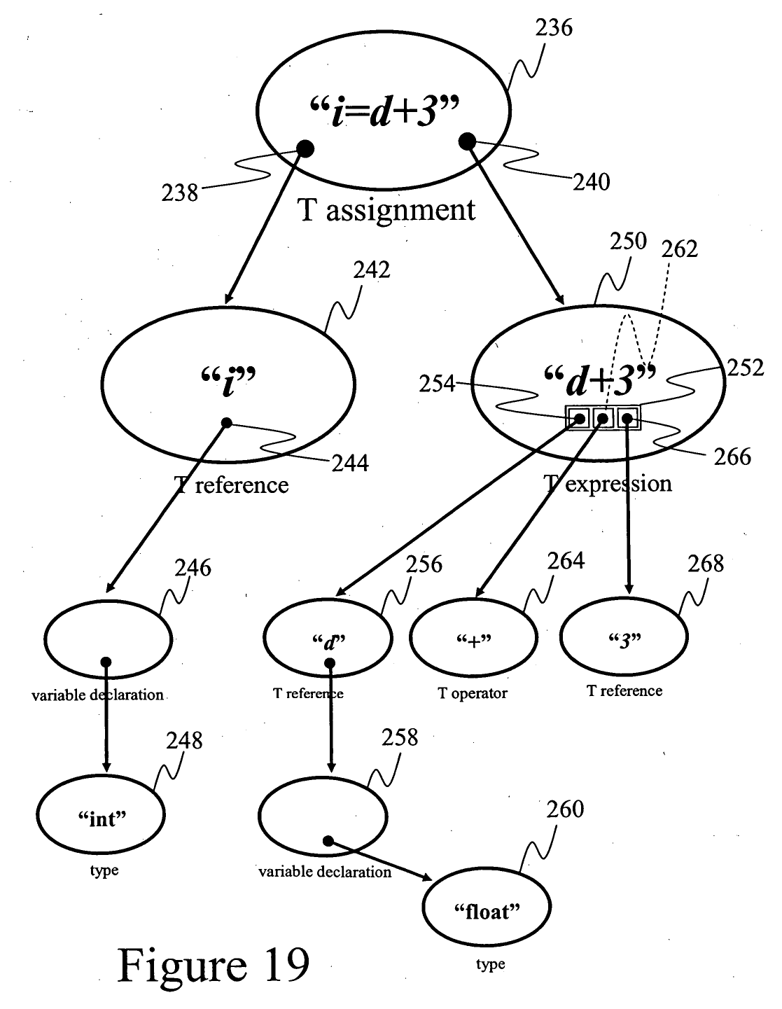

FIG. 18 shows the operation of the parser 40 of FIG. 16 in greater detail. The parser 40 of FIG. 16 is comprised of one or more lexical analyzers 232 and one or more corresponding grammatical analyzers 234. The function of the lexical analyzer 232 is to read the source files 38 which are written in a particular language, for example, Java, Visual Basic, C#, or Object Pascal. The lexical analyzer 232 reads the source file 38 and generates a token stream comprised of tokens which represent meaningful pieces of the source file 38. For example, a token may contain a single quoted string from the source file 38, the name of an identifier, a numeric constant, or a keyword from the corresponding high-level language. There are many other examples of tokens that may be generated by the lexical analyzer 232, as will be appreciated by those of skill in the art. As the token stream is generated by the lexical analyzer 232, the corresponding grammatical analyzer 234 consumes the token stream and produces the semantic map 42. In one sense, the operation of the grammatical analyzer 234 is similar to that of the lexical analyzer 232, except that instead of reading characters, the grammatical analyzer 234 is reading tokens as its unit of input. Also, the output of the grammatical analyzer 234 is not a linear stream of tokens, but rather a structured tree of nodes which, in one embodiment, is hierarchical. Although various tools are available to assist in the creation of the lexical analyzer 232 and grammatical analyzer 234, it is also possible to engineer these by hand coding techniques. The various advantages and disadvantages of these varied approaches will be evident to those of skill in the art.

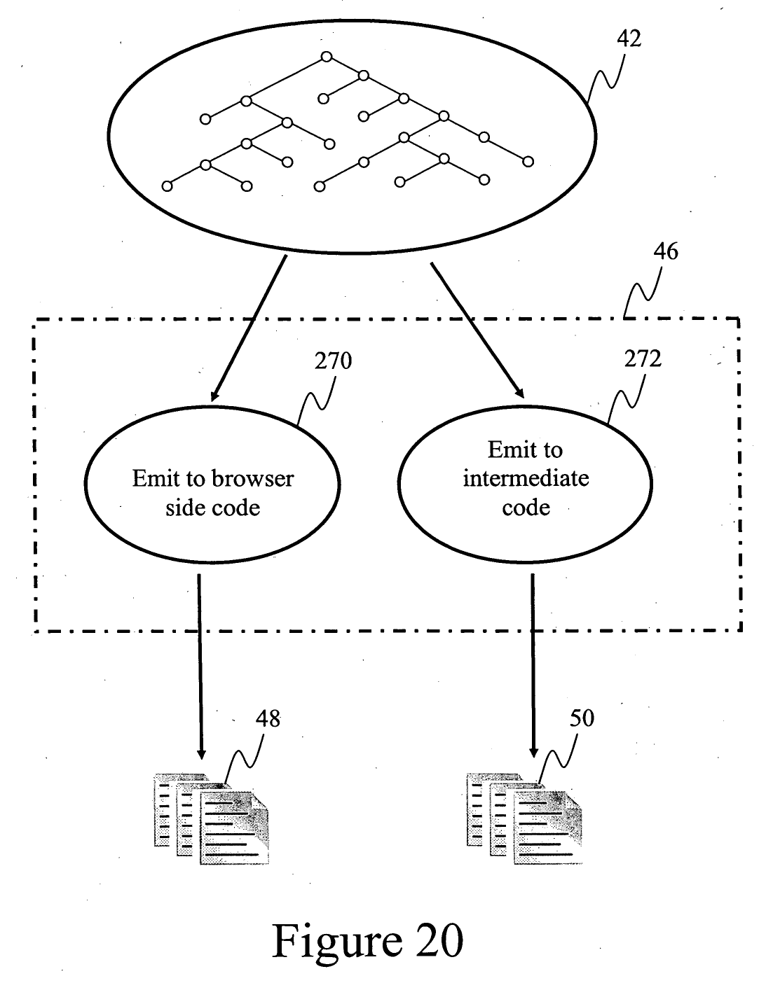

FIG. 19 is an exemplary portion of the semantic map 42 shown in FIG. 16 in greater detail. This particular portion of the semantic map 42 represents an assignment statement wherein a variable i is said to be equal to the sum of a variable d plus the constant value “3”. In a non-limiting exemplary embodiment, all nodes in the semantic map 42 are comprised of objects which are instances of various classes descending from a common base class. A top level node 236 represents the assignment statement as a whole. The node 236 is an instance of a class T assignment which is used to represent an assignment statement. The node 236 has pointers to other nodes in the tree. In this case, there is a left pointer 238 and a right pointer 240.

The left pointer 238 points to a node 242 which represents the variable i in the foregoing assignment statement. The node 242 is an instance of the T reference class. In this example, a single pointer 244 is contained in the node 242 which points to a variable declaration 246. The variable declaration 246 represents the variable declaration for the variable i which would have been encountered in a previous statement. In an alternative embodiment, the variable declaration 246 would not be referred to by the node 242, but rather a symbol table would be constructed during a walk of the semantic map 42. The variable declaration 246 specifies the type 248 of the variable i in this example. In this case, the variable i is of type integer.

Referring again to the node 236, a node 250 represents the right side expression. As will be appreciated by those of skill in the art, the right pointer 240 points to an expression which represents the right side of the assignment statement. An ordered list 252 contains a list of pointers to various objects which make up the meaning of the expression 250. A pointer 254 refers to an instance of the T reference class, and represents the variable d in the expression. Similar to the case of the node 242 for the variable i, the node 256 represents the variable d which contains a pointer to a variable declaration 258 which, in turn, contains a pointer to a type object 260.

The ordered list 252 of the node 250 also contains a pointer 262. The pointer 262 points to a node 264 which represents an addition operator.

Additionally, the ordered list 252 of the node 250 also contains a third pointer 266 which refers to a node 268 that represents the constant “3”. Another contemplated embodiment would have the node 256 and node 268 as sub-nodes of the node 264.

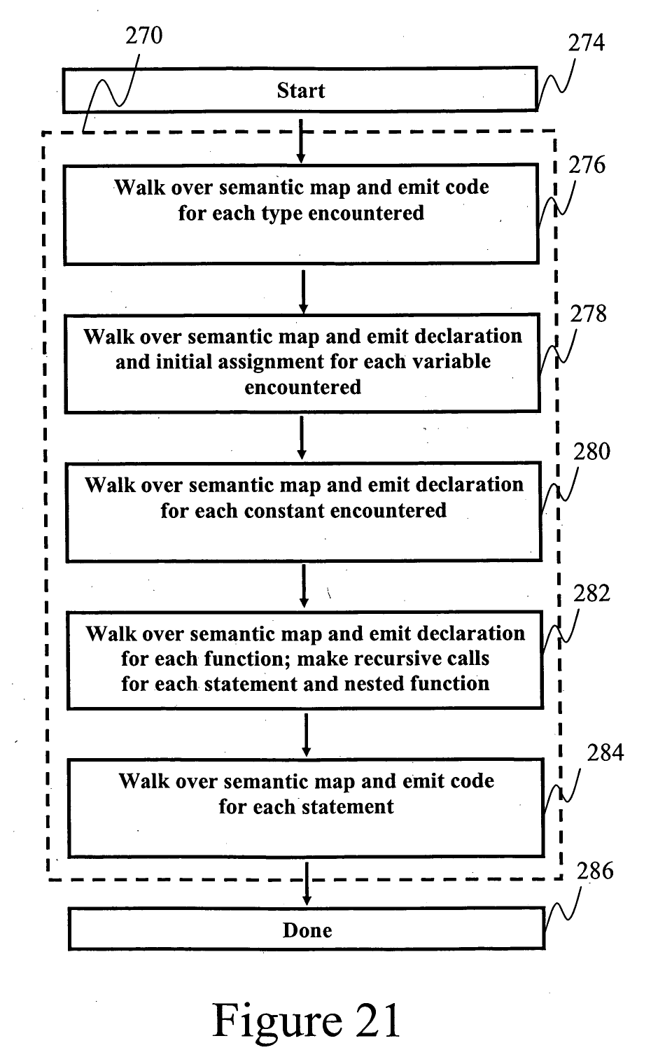

FIG. 20 depicts the process by which the semantic map 42 is emitted into browser-side code 48 and intermediate code 50 by the emitter 46 shown here in greater detail. The emitter 46 is illustrated to be comprised of two emitters, namely, emit to browser-side code 270 and emit to intermediate code 272. As will be appreciated by those of skill in the art, emit to intermediate code 272 performs a function of mapping the semantic map 42 to a high-level language similar to the original language or languages from which the semantic map 42 was derived. Persons of skill in the art will further appreciate that the object model of the intermediate code 50 is similar to that of the original code embodied in the source files 38. The process of emit to intermediate code 272 is therefore a straight translation from the original code embodied in the source files 38.

Emit to browser-side code 270, however, must reconcile the differences between the object model embodied in the semantic map 42 with the object model of the target language, i.e., JavaScript. It should be understood that this is a non-limiting example and the teachings given herein may be applied to a great many target languages. In general, the process of emit to browser-side code 270 involves superimposing the object model of original source files 38 onto the language constructs provided in the target language. For example, JavaScript provides a system of prototypes whereby each class has an associated prototype object containing a set of name value pairs which are used to dynamically construct lookup tables for method dispatching. Persons of skill in the art will appreciate that prototype systems such as that provided by JavaScript are unwieldy in that they may produce unexpected results unless utilized with great care by a person of expert-level skill. Certain embodiments disclosed herein provide a system whereby a person of skill in another object-oriented language such as Java or Object Pascal may write code in their language of preference and have it translated into code in the target language, JavaScript. The process of emit to browser-side code 270 achieves this type of translation.

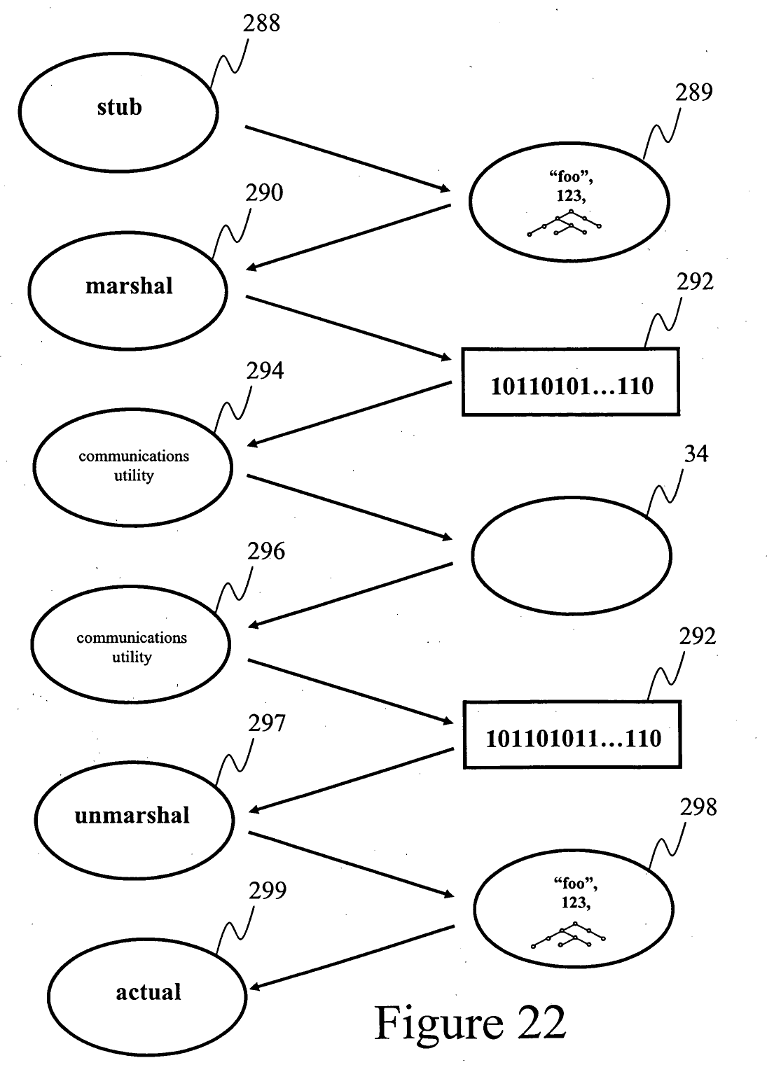

FIG. 21 shows the process of emit to browser-side code 270 in greater detail. The process begins in an operation 274 and continues in an operation 276 wherein a walk over the semantic map 42 is initiated. This walk over the semantic map 42 emits code for the various types or classes encountered in the semantic map 42. It is to be understood that the operation of emit to browser-side code 270 is performed in the context of a specific portion of the semantic map 42. The operation 276 walks over the specified portion of the semantic map 42, and when it encounters a type or class definition, it emits appropriate infrastructure code for that type or class. When the operation 276 encounters other constructs such as function declarations, it simply steps over them and emits nothing.

Upon completion of the operation 276, an operation 278 initiates a walk over the semantic map 42. As with the previous operation, this operation executes in the context of a portion of the semantic map 42. As the walk is conducted, a declaration and an initial assignment are emitted for each variable that is encountered during the walk. For example, if a local variable is encountered, a declaration for that variable is emitted; otherwise, a default initial value is given for this variable unless an initial value is given in its declaration. In an alternative embodiment, a default value is given and the initial assignment overwrites the default value. As with the previous operation, this operation walks over various objects encountered during its walk which do not apply to its purpose.

An operation 280 initiates a walk over the semantic map 42 and emits a declaration for each constant that is encountered. As with the previous operations, this operation steps over nodes in the semantic map 42 that are not relevant to this task.

An operation 282 initiates a walk over the semantic map 42 and emits a declaration for each function that is encountered. As with the previous operations, this operation is performed in the context of a specific portion of the semantic map 42. As the walk over operation 282 is performed, a recursive call to emit to browser-side code 270 is made for the various functions that are encountered. Thus, the operation 282 is essentially responsible for providing repeated calls to emit to browser-side code 270 for the various levels of scope that are encountered. During one of these recursive calls, as will be appreciated by those of skill in the art, declarations for other types of objects are emitted, such as those of the previous operations 276, 278, and 280. Also, any nested functions that may be encountered will be handled by the operation 282 at the deeper level of recursion.

Upon the completion of the operation 282, an operation 284 initiates a walk over the semantic map 42 in the context of a specific portion of the semantic map 42. For each statement that is encountered, code is emitted in the target language which embodies that statement. As with operations 276, 278, and 280, the operation 284 is performed at various levels of recursion caused by the operation 282. Upon completion of the operation 284, emit to browser-side code 270 is concluded in an operation 286.

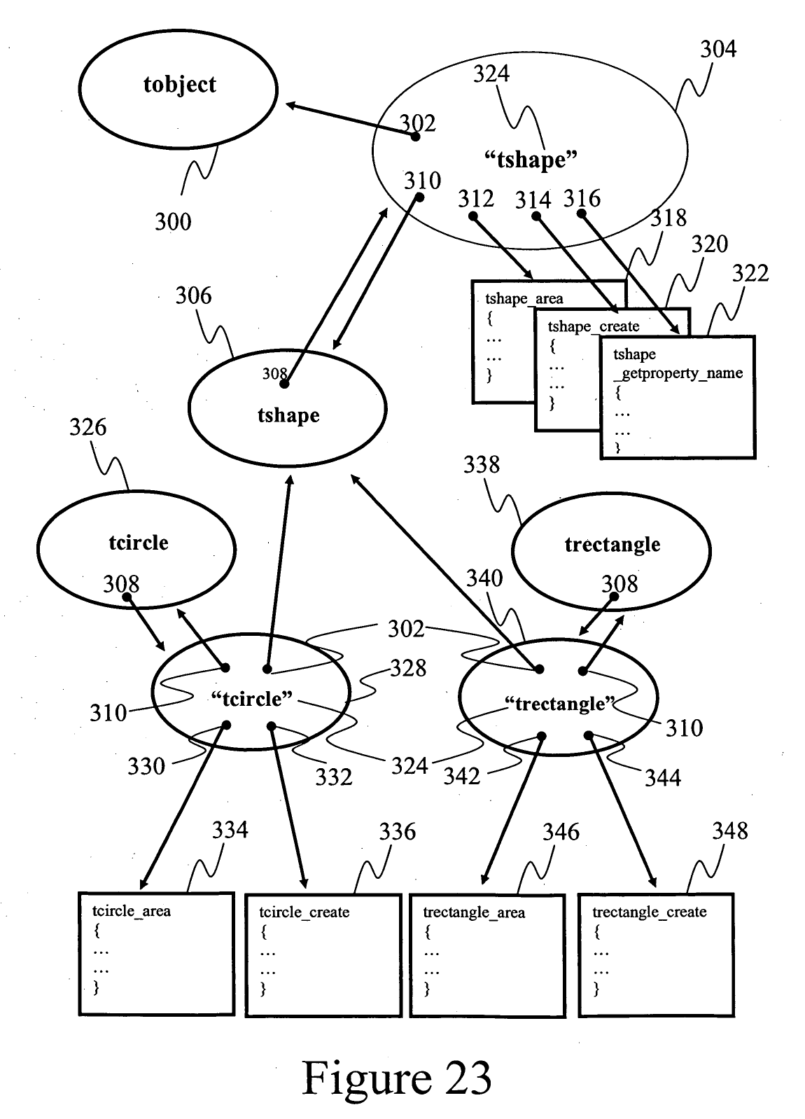

FIG. 22 depicts a run-time arrangement of various routines which support remote procedure calls. Such remote procedure calls may be emitted during the operation of emit to browser-side code 270, and in particular by the operation 282 therein. When a declaration is emitted for a remote function, a stubbed implementation of that function is also emitted. A stub routine 288 has the same calling sequence that the actual routine on the server-side machine 36 has. Upon receiving various parameters 289, stub routine 288 passes the parameters 289 to a marshaling routine 290 which performs the function of serializing the parameters 289 into a serialized form 292. The marshaling routine 290 typically will emit a code representing the type of the variable or parameter being passed followed by the data for that parameter. For example, if the parameter is an integer with a value of “5”, the marshaling routine 290 would emit a code corresponding to the type “integer” followed by a binary representation of the number “5”. The various parameters 289 are emitted into serialized form 292 one-by-one. In some cases, a parameter may be an object containing references to other objects. As long as the graph of objects does not contain references to objects that cannot be serialized, the graph of objects is serialized by a recursive walk and emitted into serialized form 292. Once the marshaling routine 290 has completed the serialization operation, a communications utility 294 transmits serialized form 292 across the Internet 34 to be received by the server-side machine 36. On the server-side machine 36, a communications utility 296 receives the data and reconstitutes it as serialized form 292 on the server-side machine 36. An unmarshaling routine 297 consumes serialized form 292 and produces parameters 298 which are essentially identical to the parameters 289 on the client-side machine 32. Each parameter is reconstructed to be semantically identical to its form on the client-side machine 32. As will be appreciated by those of skill in the art, the various pointers in a graph of objects passed as a parameter will not be identical, but rather they will be semantically identical because the topology of the graph and the identity of the objects contained therein will conform to the semantics of the corresponding graph of objects on the client-side machine 32. Once the parameters 298 have been reconstituted by the unmarshaling routine 297, they are passed to an actual routine 299 for processing. Persons of skill in the art will appreciate that the parameters 298 may include an identifier of an object on the server-side machine 36 instead of a reference to an object on the server-side machine 36. Persons of skill in the art will further appreciate that the parameters 298 may also contain a selector code which identifies a specific method to be invoked on the specified object. The actual routine 299 processes the call and returns a return value in some cases. The return value is returned using a similar mechanism as was used to transport the parameters 289 across the Internet 34 to be reconstituted as the parameters 298. Persons of skill in the art will appreciate that in addition to the normal return mechanism, the actual routine 299 may throw an exception which is propagated using similar means. The exception is treated as a data object for purposes of marshaling and transmission, and then on the client side, it is interpreted and rethrown as an exception.

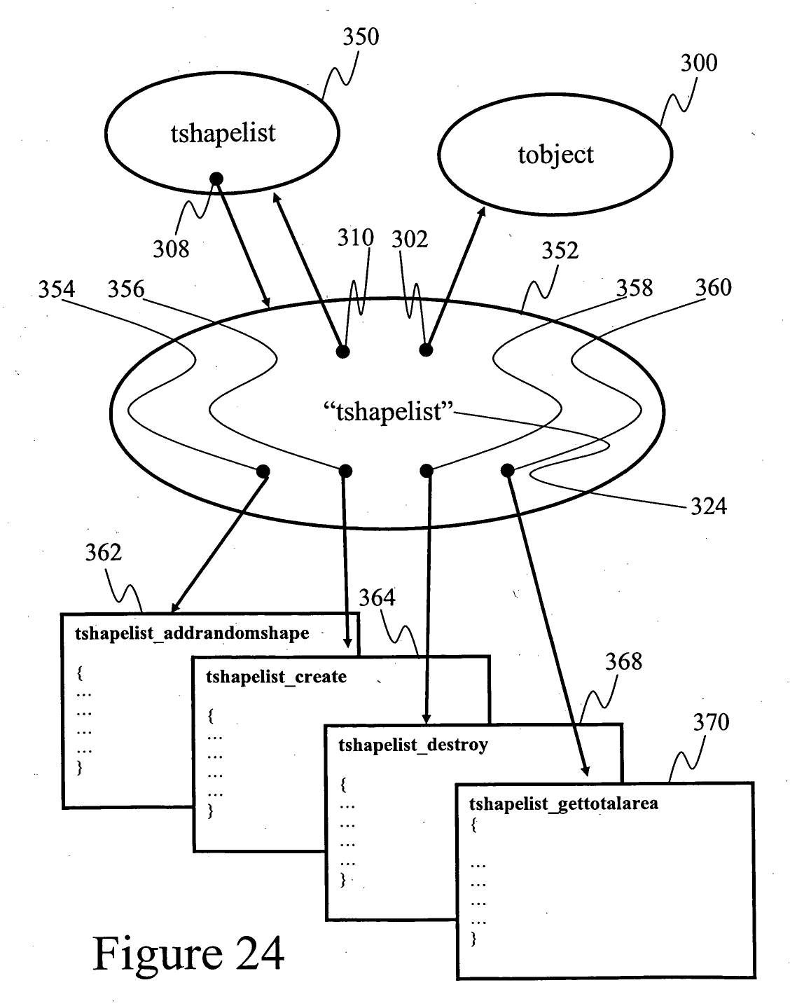

FIG. 23 and FIG. 24 depict a set of example classes as they appear in the memory of the client-side machine 32 at run-time. The infrastructure code emitted for various classes by the operation 276 shown in FIG. 21 is disposed to construct the various classes and their prototypes so as to mimic the object model of a class-based source language. In order to illustrate the techniques used to cast the class-based language constructs into a prototype-based framework, these example classes are presented.

As will be appreciated by those of skill in the art, prototype-based programming is a style of object-oriented programming in which classes are not present, and behavior reuse (known as inheritance in class-based languages) is accomplished through a process of cloning existing objects which serve as prototypes. This model is also known as classless, prototype-oriented, or instance-based programming.

With class-based languages, objects come in two general types. Classes define the basic layout and functionality of objects, and instances are “usable” objects based on the patterns of a particular class. In this model, classes act as collections of behavior (methods) and structure which are the same for all instances, whereas instances carry the objects' data. The role distinction is thus primarily based on a distinction between structure and behavior on the one hand, and state on the other. In practice, it is difficult for persons accustomed to coding in class-based languages such as Java and Object Pascal to write correct, safe, and predictable code in a prototype-based language.

The hierarchy of classes depicted in FIG. 23 and FIG. 24 is meant to illustrate, in a non-limiting way, one possible arrangement of prototypes that is disposed to mimic class-based behavior. This class hierarchy is illustrative of the generated code example provided in Appendix 1.

A class tobject 300 is shown in FIG. 23 as the top of the class hierarchy. It is referenced by a parent class pointer 302 in tshape prototype 304, which is the prototype for class tshape 306. A prototype pointer 308 of the class tshape 306 refers to tshape prototype 304. A class pointer 310 in tshape prototype 304 points to class tshape 306. The tshape prototype 304 also contains tshape_area pointer 312, tshape_create pointer 314, and tshape_getproperty_name pointer 316 which point to area dispatcher 318, create dispatcher 320, and getproperty_name dispatcher 322, respectively. A class name string 324 contains the name of the class, in this case “tshape”.

Class tcircle 326 has a prototype pointer 308 which points to tcircle prototype 328. Tcircle prototype 328 has a class name string 324 containing the name of the class, in this case “tcircle”, a class pointer 310 which points to class tcircle 326, a parent pointer 302 which points to the class tshape 306, as well as tcircle_area pointer 330 and tcircle_create pointer 332 which point to area dispatcher 334 and create dispatcher 336, respectively.

Class trectangle 338 has a prototype pointer 308 which points to rectangle prototype 340. Trectangle prototype 340 has a class name string 324 containing the name of the class, in this case “trectangle”, a class pointer 310 which points to class trectangle 338, a parent pointer 302 which points to the class tshape 306, as well as a trectangle_area pointer 342 and trectangle_create pointer 344 which point to area dispatcher 346 and create dispatcher 348, respectively.

In FIG. 24, class tshapelist 350 has a prototype pointer 308 which points to tshapelist prototype 352. Tshapelist prototype 352 has a class name string 324 containing the name of the class, in this case “tshapelist”, a class pointer 310 which points to class tshapelist 350, a parent pointer 302 which points to the class tobject 300, as well as tshapelist_addrandomshape pointer 354, tshapelist_create pointer 356, tshapelist_destroy pointer 358, and tshapelist_gettotalarea pointer 360 which point to addrandomshape dispatcher 362, create dispatcher 364, destroy dispatcher 368, and gettotalarea dispatcher 370, respectively.

With continuing reference to FIG. 23 and FIG. 24, at run-time, dynamic method dispatching takes place by calling a dispatcher corresponding to the desired method. In one embodiment, the dispatcher receives the parameters that are intended for the method implementation that will ultimately service the request, and is thus customized for a particular calling sequence of parameters. The calling sequence may include utility parameters that were not included in the original source code, but which assist in the dispatching operation or other operations.

In certain embodiments, when operation 276 shown in FIG. 21 emits infrastructure code segments for a given class that it encounters during its walk of the semantic map 42, it emits dispatcher code segments for each method that is callable in the class. Subsequently, when the operation 284 shown in FIG. 21 emits code segments corresponding to method calls it encounters during its walk of the semantic map 42, it emits method call code segments which invoke the dispatcher code segment for that method.

The method dispatcher code segment evaluates the call based on the class associated with the object in the context of which the method was invoked. The method dispatcher code segment uses this information along with the data structures illustrated in FIG. 23 and FIG. 24 to identify a method implementation that must be executed to service the method call in the context of the given object. Once the method implementation code segment to be executed is identified, it is executed. The method implementation code segment is supplied with the identity of the object in the context of which the method was invoked, as well as any parameters that are part of the calling sequence. Additional utility parameters may also be supplied.

In one embodiment, the method implementation may be embodied as a dispatcher code segment which uses conditional logic to determine that no further dispatch is needed. In this embodiment, a method implementation code segment is invoked, and is supplied with the identity of the object in the context of which the method was invoked, as well as any parameters that are part of the calling sequence.

To illustrate a particular embodiment of dynamic method dispatching, the following example is provided with reference to FIG. 23 and FIG. 24. During the execution of a code segment in gettotalarea dispatcher code segment 370, an iteration over various object instances is performed in which polymorphic method invocations requiring dynamic method invocation are performed. In particular, the “area” method of each instance is called, the result of which is added to a total area variable. In this case, the object instances are treated as instances of tshape, although they are in certain embodiments instances of subclasses of the common base class tshape. As each instance is encountered during the iteration, the area method is invoked for that object.

An exemplary method dispatch for the area method of a tcircle instance occurs as follows. The area dispatcher code segment 318 is invoked which examines the class associated with the instance. This is accomplished by following class pointer 310 in the tcircle instance (which was cloned at instantiation time from tcircle prototype 328) in order to obtain class tcircle 326.

This class is compared for equality to class tshape 306. Upon determining that the instance is not of class tshape, the dispatcher code segment determines whether or not there is any code segment referred to by tcircle_prototype 328 that implements the area method. This is done by examining the name value pairs contained in tcircle prototype 328 to determine whether or not a pointer corresponding to the method name “area” exists.

In this case, it is determined that tcircle prototype 328 contains a pointer corresponding to the method name “area”, and the pointer is followed in the context of the tcircle instance, indicating that the class tcircle provides an override of the area method. Thus, the code segment corresponding to the method override is invoked. If the pointer corresponding to a method override is not present, the area dispatcher code segment would continue walking to the various base classes of tcircle by traversing the chain of parent pointers 302, looking for a pointer corresponding to the method name “area”, and upon finding it, following it as described above.

Persons of skill in the art will appreciate that since object instances are cloned from the prototypes of their respective classes, cloned data structures or unmodified portions of cloned data structures may be used interchangeably with the data structures from which they were derived.

In conclusion, prior to the present invention, the client-side component of all web applications that run natively in the browser (i.e., without requiring additional plug-ins or virtual machine downloads) were developed by programming in JavaScript, which is a non-compiled (interpreted) language. This has greatly hindered web application development, as the usage of JavaScript is currently approximately only 1.4 %. Using the various embodiments of the present invention, web developers can, for the first time, bring the skills and sophistication of traditional desktop software methodologies to the world of web development. This allows those trained in the field of desktop software development to join the world of the web, a world previously dominated by web designers, graphic artists, and hobbyist programmers. Such sophistication offers programmers the ability to abstract themselves away from many of the limitations of JavaScript and take advantage of the many benefits that they are accustomed to, including a statically and preferably strongly typed compiled language. Furthermore, this methodology eliminates one of the biggest banes of web development, namely, the writing of cross-browser code.

The use of a compiler that compiles from a high-level language in developing a web application in accordance with the various embodiments of the present invention offers many distinct advantages to writing directly in a scripting language such as JavaScript. These advantages include: class-based object-orientation; easier refactoring; elimination or reduction of common run-time errors (mainly via type checking); and programming abstraction away from cross-browser issues and incompatibilities and improved readability.

While the foregoing description has been with reference to particular embodiments of the present invention, it will be appreciated by those skilled in the art that changes to these embodiments may be made without departing from the principles and spirit of the invention. The principles of the present invention are applicable to any system (for example, a Personal Digital Assistant, Palm device, mobile phone, ADSL modems, routers, embedded devices, etc.) in which the user interfaces an application via a browser. Further, provided that the user accesses the application via a browser, the web site or software application could either be run locally or remotely. Accordingly, the scope of the present invention can only be ascertained with reference to the appended claims.

APPENDIX 1A.
A Summary of key object-oriented functionalities

| | |
|---|---|
| Inheritance | full object inheritance in contrast to JavaScript's inheritance via |
| | prototypes. [21→5, 6, 9]. Note especially the ability to |
| | implement class reference types via the Class of syntax [17→207-212]. |
| Methods (static) | [43(144-165)→203-222] |
| Methods (virtual) | used in conjunction with overriding methods [7(61-67)→62-68] |
| | in conjunction with overriding methods [24 (85-91)→115-126] |
| | Associated with this is the ability to access methods of parent |
| | objects, via the syntax inherited [89→119] |
| Polymorphism | [175→264] |
| Visibility | Private [10→n/a], |
| | Protected, |
| | Public (default) [23→124], and |
| | Published |
| Properties | [12-193] |
| Type Checking | Via the is syntax [155→214] |
| Type Casting | [156→215] |
| Type Conversion | due to strong-typing, the invention allows conversion of types, |
| | for example from integers to strings. This is done via a function |
| | in the run-time library [185→133]. |
| Interface | [52→n/a] |

Note:
This table is to be used in conjunction with Appendix 1B and 1C.

APPENDIX 1B
Example Code
(Input - Object-oriented code using a Pascal-like syntax)

| 1 | BrowserModule BrowserModule1; | |
|---|---|---|
| 2 | | |
| 3 | Type | |
| 4 | {......................................................................} | |
| 5 | TShape = Class | |
| 6 | Color : TColor; | |
| 7 | Constructor | Create; Virtual; |
| 8 | Function | Area : Real ; Virtual; |
| 9 | Private | |
| 10 | Function GetProperty_Name : String; | |
| 11 | Public | |
| 12 | Property | Name : String Read GetProperty_Name; |
| 13 | End; | |
| 14 | {......................................................................} | |
| 15 | | |
| 16 | {......................................................................} | |
| 17 | TShapeClass = Class of TShape; | |
| 18 | {......................................................................} | |
| 19 | | |
| 20 | {......................................................................} | |
| 21 | TCircle = Class (TShape) | |
| 22 | Public | |
| 23 | Radius : Real; | |
| 24 | Constructor | Create; Override; |
| 25 | Function | Area : Real; Override; |
| 26 | End; | |
| 27 | {......................................................................} | |
| 28 | | |
| 29 | {......................................................................} | |
| 30 | TRectangle = Class (TShape) | |
| 31 | Height : Real; | |
| 32 | Width : Real; | |
| 33 | Constructor | Create; |
| 34 | Function | Area : Real; Override; |
| 35 | End; | |
| 36 | {......................................................................} | |
| 37 | | |
| 38 | {......................................................................} | |
| 39 | TShapeList = Class | |
| 40 | Shapes : List of TShape; | |
| 41 | Constructor | Create; |
| 42 | Destructor | Destroy; Override; |
| 43 | Function | AddRandomShape; |
| 44 | Function | GetTotalArea : Integer; |
| 45 | End; | |

| 46 | {......................................................................} | |
|---|---|---|
| 47 | | |
| 48 | {......................................................................} | |
| 49 | Function Test; | |
| 50 | {......................................................................} | |
| 51 | | |
| 52 | Implementation | |
| 53 | | |
| 54 | Const | |
| 55 | {......................................................................} | |
| 56 | cDefaultHeight = 1; | |
| 57 | cDefaultWidth = 1; | |
| 58 | {......................................................................} | |
| 59 | | |
| 60 | {......................................................................} | |
| 61 | Constructor TShape.Create; | |
| 62 | Const | |
| 63 | DefaultColor = $FFFFFF; | |
| 64 | Begin | |
| 65 | Inherited Create; | |
| 66 | Color := DefaultColor; | |
| 67 | End; | |
| 68 | {......................................................................} | |
| 69 | | |
| 70 | {......................................................................} | |
| 71 | Function TShape.GetProperty_Name : String; | |
| 72 | Begin | |
| 73 | Result := ClassName; // + ColorToHTMLHex(Color); | |
| 74 | End; | |
| 75 | {......................................................................} | |
| 76 | | |
| 77 | {......................................................................} | |
| 78 | Function TShape.Area : Real; | |
| 79 | Begin | |
| 80 | Result := 0; | |
| 81 | End; | |
| 82 | {......................................................................} | |
| 83 | | |
| 84 | {......................................................................} | |
| 85 | Constructor TCircle.Create; | |
| 86 | Const | |
| 87 | DefaultRadius = 0; | |
| 88 | Begin | |
| 89 | Inherited Create( ); | |
| 90 | Radius := DefaultRadius; | |
| 91 | End; | |
| 92 | {......................................................................} | |
| 93 | | |
| 94 | {......................................................................} | |
| 95 | Function TCircle.Area : Real; | |
| 96 | Const | |
| 97 | Pi = 3.1415926; | |
| 98 | Begin | |
| 99 | Result := Pi * Radius * Radius | |
| 100 | End; | |
| 101 | {......................................................................} | |
| 102 | | |
| 103 | {......................................................................} | |
| 104 | Constructor TRectangle.Create; | |
| 105 | Begin | |
| 106 | Inherited Create; | |
| 107 | Height := cDefaultHeight; | |
| 108 | Width : = cDefaultHeight; | |
| 109 | End; | |
| 110 | {......................................................................} | |
| 111 | | |
| 112 | {......................................................................} | |
| 113 | Function TRectangle.Area : Real; | |
| 114 | Begin | |
| 115 | Result := Height * Width; | |
| 116 | End; | |
| 117 | {......................................................................} | |
| 118 | | |
| 119 | {......................................................................} | |
| 120 | Constructor TShapeList.Create; | |
| 121 | Var | |
| 122 | i : Integer; | |
| 123 | Begin | |
| 124 | Inherited Create; | |
| 125 | Shapes.Init; | |
| 126 | For i := 0 to 10 Do | |
| 127 | AddRandomShape; | |
| 128 | End; | |
| 129 | {......................................................................} | |
| 130 | | |
| 131 | {......................................................................} | |
| 132 | Destructor TShapeList.Destroy; | |
| 133 | Var | |
| 134 | i : Integer; | |
| 135 | Begin | |
| 136 | For i := 0 to Shapes.Count, − 1 Do | |
| 137 | Shapes[i].Free; | |
| 138 | Shapes.Free; | |
| 139 | Inherited Destroy; | |
| 140 | End; | |
| 141 | {......................................................................} | |
| 142 | | |
| 143 | {......................................................................} | |
| 144 | Function TShapeList .AddRandomShape; | |
| 145 | Var | |
| 146 | ShapeClass : TShapeClass; | |
| 147 | Shape : TShape; | |
| 148 | begin | |
| 149 | If Random(10) < 5 | Then ShapeClass := TCircle |
| 150 | | Else ShapeClass := TRectangle; |
| 151 | | |

| | |
|---|---|
| 152 | Shape := ShapeClass.Create; |
| 153 | Shape.Color := $ff0000; |
| 154 | |
| 155 | If Shape is TCircle Then |
| 156 | TCircle(Shape).Radius := Random(14) |
| 157 | Else |
| 158 | If Shape is TRectangle Then |
| 159 | Begin |
| 160 | TRectangle(Shape).Width := Random(20); |
| 161 | TRectangle(Shape).Height := Random(10); |
| 162 | End; |
| 163 | |
| 164 | Shapes.Add(Shape); |
| 165 | End; |
| 166 | {......................................................................} |
| 167 | |
| 168 | {......................................................................} |
| 169 | Function TShapeList.GetTotalArea : Integer; |
| 170 | Var |
| 171 | i : Integer; |
| 172 | Begin |
| 173 | Result := 0; |
| 174 | For i := 0 to Shapes.Count − 1 Do |
| 175 | Result := Result + Shapes[i].Area; |
| 176 | End; |
| 177 | {......................................................................} |
| 178 | |
| 179 | {......................................................................} |
| 180 | Function Test; |
| 181 | Var |
| 182 | ShapeList : TShapeList; |
| 183 | Begin |
| 184 | ShapeList := TShapeList.Create; |
| 185 | ShowMessage(IntToStr(ShapeList.Shapes.Count) + ‘ ’ + |
| | IntToStr(ShapeList.GetTotalArea)); |
| 186 | ShapeList.Free; |
| 187 | End; |
| 188 | {......................................................................} |
| 189 | |
| 190 | End. |

APPENDIX 1C
Example Code
(Output - Browser-side JavaScript)

| | |
|---|---|
| 1 | //....................................................................... |
| 2 | function tcircle( ){ } |
| 3 | function Register_tcircle( ){ |
| 4 | if(IsRegisteredtcircle)return; |
| 5 | Register_tshape( ); |
| 6 | tcircle.prototype=p=new tshape( ); |
| 7 | p.t7=“tcircle”; |
| 8 | p.t8=tcircle; |
| 9 | p.ParentClass=tshape; |
| 10 | p.tcircle_area=tcircle_area; |
| 11 | p.tcircle_create=tcircle_create; |
| 12 | IsRegisteredtcircle=true; |
| 13 | } |
| 14 | function Create_tcircle(p){ |
| 15 | Register_tcircle( ); |
| 16 | if(p==void(0))p=new tcircle( ); |
| 17 | p=Create_tshape(p); |
| 18 | p.t7=“tcircle”; |
| 19 | p.radius=null; |
| 20 | return p |
| 21 | } |
| 22 | //....................................................................... |
| 23 | |
| 24 | //....................................................................... |
| 25 | function trectangle( ){ } |
| 26 | function Registier_trectangle( ){ |
| 27 | if(IsRegisteredtrectangle)return; |
| 28 | Register_tshape( ); |
| 29 | trectangle.prototype=p=new tshape( ); |
| 30 | p.t7=“trectangle”; |
| 31 | p.t8=trectangle; |
| 32 | p.ParentClass=tshape; |
| 33 | p.trectangle_area=trectangle_area; |
| 34 | p.trectangle_create=trectangle_create; |
| 35 | IsRegisteredtrectangle=true; |
| 36 | } |
| 37 | function Create_trectangle(p){ |
| 38 | Register_trectangle( ); |
| 39 | if(p==void(0))p=new trectangle( ); |
| 40 | p=Create_tshape(p); |
| 41 | “ p.t7=“trectangle”;” |
| 42 | p.height=null; |
| 43 | p.width=null; |
| 44 | return p |
| 45 | } |
| 46 | //....................................................................... |
| 47 | |
| 48 | //....................................................................... |
| 49 | function tshape( ){ } |
| 50 | function Register_tshape( ){ |
| 51 | if(IsRegisteredtshape)return; |
| 52 | Register_tobject( ); |
| 53 | tshape.prototype=p=new tobject( ); |
| 54 | p.t7=“tshape”;“ |
| 55 | p.t8=tshape; |
| 56 | p.ParentClass=tobject; |
| 57 | p.tshape_area=tshape_area; |
| 58 | p.tshape_create=tshape_create; |
| 59 | p.tshape_getproperty_name=tshape_getproperty_name; |
| 60 | IsRegisteredtshape=true; |
| 61 | } |
| 62 | function Create_tshape(p){ |
| 63 | Register_tshape( ); |
| 64 | if(p==void(0))p=new tshape( ); |
| 65 | p=Create_tobject(p); |
| 66 | p.t7=“tshape”; |
| 67 | p.color=null; |
| 68 | return p |
| 69 | } |
| 70 | //....................................................................... |
| 71 | |
| 72 | //....................................................................... |
| 73 | function tshapelist( ){ } |
| 74 | function Register_tshapelist( ){ |
| 75 | if(IsRegisteredtshapelist)return; |
| 76 | Register_tobject( ); |
| 77 | tshapelist.prototype=p=new tobject( ); |
| 78 | p.t7=“tshapelist”; |
| 79 | p.t8=tshapelist; |
| 80 | p.ParentClass=tobject; |
| 81 | p.tshapelist_addrandomshape=tshapelist_addrandomshape; |
| 82 | p.tshapelist_create=tshapelist_create; |
| 83 | p.tshapelist_destroy=tshapelist_destroy; |
| 84 | p.tshapelist_gettotalarea=tshapelist_gettotalarea; |
| 85 | IsRegisteredtshapelist=true; |
| 86 | } |
| 87 | function Create_tshapelist(p){ |
| 88 | Register_tshapelist( ); |
| 89 | if(p==void(0))p=new tshapelist( ); |
| 90 | p=Create_tobject(p); |
| 91 | p.t7=“tshapelist”; |
| 92 | p.shapes=null; |
| 93 | return p |
| 94 | } |
| 95 | //....................................................................... |
| 96 | |
| 97 | var cdefaultheight=null;cdefaultheight=1; |
| 98 | var cdefaultwidth=null;cdefaultwidth=1; |
| 99 | //....................................................................... |
| 100 | function tcircle_area(IsStatic){ |
| 101 | var _this=this; |
| 102 | if(_this.t8!=tcircle) |
| 103 | if(IsStatic==void(0)){ |
| 104 | if(svm(“_area”,tcircle,_this))return _this.- |
| | vmd(true)‘’ |
| 105 | } |
| 106 | |
| 107 | var result=null; |
| 108 | var pi=null;pi=3.1415926; |
| 109 | result=pi * _this.radius * _this.radius; |
| 110 | return result; |
| 111 | } |
| 112 | //....................................................................... |
| 113 | |
| 114 | //....................................................................... |
| 115 | function tcircle_create(IsStatic){ |
| 116 | var _this=this; |
| 117 | if(_this.t8!=tcircle) |
| 118 | if(IsStatic==void(0)){ |
| 119 | if(svm(“_create”,tcircle,_this))return _this.- |
| | vmd(true)‘’ |
| 120 | } |
| 121 | |
| 122 | var defaultradius=null;defaultradius=0; |
| 123 | _this.tshape_create(true); |
| 124 | _this.radius=defaultradius; |
| 125 | return _this; |
| 126 | } |
| 127 | //....................................................................... |
| 128 | |
| 129 | //....................................................................... |
| 130 | function test(IsStatic){ |
| 131 | var shapelist=null; |
| 132 | shapelist=Create_tshapelist( ).tshapelist_create( ); |
| 133 | showmessage((inttostr(shapelist.shapes.fcount) + “ “+ |
| | inttostr(shapelist.tshapelist_gettotalarea( )))); |
| 134 | shapelist.tobject_free( ); |
| 135 | } |
| 136 | //....................................................................... |
| 137 | |
| 138 | //....................................................................... |
| 139 | function trectangle_area(IsStatic){ |
| 140 | var _this=this; |
| 141 | if(_this.t8!=trectangle) |
| 142 | if(IsStatic==void(0)){ |
| 143 | if(svm(“_area”,trectangle,_this))return _this.- |
| | vmd(true)‘’ |
| 144 | } |
| 145 | |
| 146 | var result=null; |
| 147 | result=_this.height * _this.width; |
| 148 | return result; |
| 149 | } |
| 150 | //....................................................................... |
| 151 | |
| 152 | //....................................................................... |
| 153 | function trectangle_create(IsStatic){ |
| 154 | var _this=this; |
| 155 | |
| 156 | _this.tshape_create(true); |
| 157 | _this.height=cdefaultheight; |
| 158 | _this.width=cdefaultheight; |
| 159 | return _this; |
| 160 | } |
| 161 | //....................................................................... |
| 162 | |
| 163 | //....................................................................... |
| 164 | function tshape_area(IsStatic){ |
| 165 | var _this=this; |
| 166 | if(_this.t8!=tshape) |
| 167 | if(IsStatic==void(0)){ |
| 168 | if(svm(“_area”,tshape,_this))return _this.- |
| | vmd(true)‘’ |
| 169 | } |
| 170 | |
| 171 | var result=null; |
| 172 | result=0; |
| 173 | return result; |
| 174 | } |
| 175 | //....................................................................... |
| 176 | |
| 177 | //....................................................................... |
| 178 | function tshape_create(IsStatic){ |
| 179 | var _this=this; |
| 180 | if(_this.t8!=tshape) |
| 181 | if(IsStatic==void(0)){ |
| 182 | if(svm(“_create”,tshape,_this))return _this.- |
| | vmd(true)‘’ |
| 183 | } |
| 184 | |
| 185 | var defaultcolor=null;defaultcolor=0xffffff; |
| 186 | _this.tobject_create(true); |
| 187 | _this.color=defaultcolor; |
| 188 | return _this; |
| 189 | } |
| 190 | //....................................................................... |
| 191 | |
| 192 | //....................................................................... |
| 193 | function tshape_getproperty_name(IsStatic){ |
| 194 | var _this=this; |
| 195 | |
| 196 | var result=null; |
| 197 | result=_this.tobject_classname( ); |
| 198 | return result; |
| 199 | } |
| 200 | //....................................................................... |
| 201 | |
| 202 | //....................................................................... |
| 203 | function tshapelist_addrandomshape(IsStatic){ |
| 204 | var _this=this; |
| 205 | |
| 206 | var shape=null; |
| 207 | var shapeclass=null; |
| 208 | if(random(10) < 5){ |
| 209 | shapeclass=tcircle; |
| 210 | }else |
| 211 | shapeclass=trectangle; |
| 212 | shape=eval(“Create_”+ |
| | shapeclass.prototype.t7)( ).tshape_create( ); |
| 213 | shape.color=0xff0000; |
| 214 | if(_IS(shape,tcircle)){‘’ |
| 215 | shape.radius=random(14); |
| 216 | }else |
| 217 | if(_IS(shape,trectangle)){‘’ |
| 218 | shape.width=random(20); |
| 219 | shape.height=random(10); |
| 220 | } |
| 221 | _this.shapes.add(shape); |
| 222 | } |
| 223 | //....................................................................... |
| 224 | |
| 225 | //....................................................................... |
| 226 | function tshapelist_create(IsStatic){ |
| 227 | var _this=this; |
| 228 | |
| 229 | var i=null; |
| 230 | _this.tobject_create(true); |
| 231 | _this.shapes= |
| | CreateList(null,null,Create_tshape,tobject_{——}create); |
| 232 | for(i=0;i<=10;i++){ |
| 233 | _this.tshapelist_addrandomshape( ); |
| 234 | } |
| 235 | return _this; |
| 236 | } |
| 237 | //....................................................................... |
| 238 | |
| 239 | //....................................................................... |
| 240 | function tshapelist_destroy(IsStatic){ |
| 241 | var _this=this; |
| 242 | if(_this.t8!=tshapelist) |
| 243 | if(IsStatic==void(0)){ |
| 244 | if(svm(“_destroy”,tshapelist,_this))return _this.- |
| | vmd(true)‘’ |
| 245 | } |
| 246 | |
| 247 | var i=null; |
| 248 | for(i=0;i<=_this.shapes.fcount − 1;i++){ |
| 249 | _this.shapes.get(i).tobject_free( ); |
| 250 | } |
| 251 | _this.shapes.free( ); |
| 252 | _this.tobject_destroy(true); |
| 253 | } |
| 254 | //....................................................................... |
| 255 | |
| 256 | //....................................................................... |
| 257 | function tshapelist_gettotalarea(IsStatic){ |
| 258 | var _this=this; |
| 259 | |
| 260 | var result=null; |
| 261 | var i=null; |
| 262 | result=0; |
| 263 | for(i=0;i<=_this.shapes.fcount − 1;i++){ |
| 264 | result=result + _this.shapes.get(i).tshape_area( ); |
| 265 | } |
| 266 | return result; |
| 267 | } |
| 268 | //....................................................................... |

What is claimed is:

1. A method to compile a web application programmed in a high-level language into browser-side JavaScript comprising:
reading at least one source file comprising the high-level language;
parsing the at least one source file to generate a semantic map to provide a structured representation of information contained in the at least one source file; and
emitting browser-side JavaScript from the semantic map, the JavaScript being produced by walking over nodes of the semantic map.

2. The method of claim 1 wherein unneeded information consisting of white space or comments is removed before generating the semantic map.

3. The method of claim 1 wherein the semantic map is an abstract syntax tree which is a finite labeled directed tree where internal nodes are labeled by operators and leaf nodes represent operands and node operators.

4. The method of claim 3 wherein the nodes in the semantic map are comprised of objects which are instances of various classes descending from a common base class.

5. The method of claim 1 wherein during the walk over the semantic map: an appropriate infrastructure code is emitted when a type or class definition is encountered; a declaration and an initial assignment are emitted for each variable that is encountered; a declaration is emitted for each constant that is encountered; a declaration is emitted for each function that is encountered; and JavaScript is emitted which embodies each statement that is encountered.

6. The method of claim 1 wherein at least a portion of the at least one source file is compiled to server-side executable code, further comprising:
emitting a stub routine for each routine or method representing a server-side operation to provide an interface that is callable by any portion of the browser-side JavaScript;
emitting intermediate code from the semantic map wherein the intermediate code is high-level language code which embodies server-side elements comprising the at least one source file to be executed in concert with the browser-side JavaScript, the intermediate code being produced by walking over the nodes of the semantic map and producing high-level language source code representative of server-side constructs found in the semantic map;
reading the intermediate code; and
compiling the intermediate code to server-side binary executable code.

7. The method of claim 6 wherein producing the high-level source code consists of mapping the semantic map to a high-level language similar to the high-level language used to program the source file from which the semantic map was derived.

8. The method of claim 6 wherein the server-side binary executable code comprises at least one of a) an implementation of each server-side routine declared in the at least one source file and b) at least one support routine to assist in the implementation of a remote procedure call.

9. A method for producing a web application that runs natively in a browser, comprising:
writing in a high-level language to develop a source file;
parsing the source file to produce a semantic map; and
processing the semantic map by emitting browser-side JavaScript comprising at least one dispatcher having a set of parameters to invoke a code segment utilizing the same set of parameters.

10. The method of claim 9 wherein the high-level language comprises a high-level language from among the programming languages consisting of Ada, C, C++, C#, COBOL, ColdFusion, Common Lisp, Delphi, Fortran, Java, Object Pascal, SmallTalk, Visual Basic, and Visual Basic.NET.

11. The method of claim 10 wherein the high-level language comprises a statically typed high-level language selected from among the programming languages consisting of Ada, C, C++, C#, Delphi, Fortran, Java, Object Pascal, SmallTalk, Visual Basic, and Visual Basic.NET.

12. The method of claim 11 wherein the high-level language is strongly typed and comprises a high-level language selected from among the programming languages consisting of Ada, C#, Delphi, Fortran, Java, Object Pascal, and Visual Basic.NET.

13. The method of claim 11 wherein the statically typed source file is directly compiled or compiled just-in-time.

14. The method of claim 9, further comprising providing an integrated design environment to facilitate writing the source file.

15. A system for producing a web application that runs natively in a browser, comprising:
a computer and software under control of a user for writing in a high-level language to develop a source file;
the software running on the computer for parsing the source file to produce a semantic map; and
the software running on the computer for processing the semantic map by emitting browser-side JavaScript comprising at least one dispatcher having a set of parameters to invoke a code segment utilizing the same set of parameters.

16. The system of claim 15 wherein the high-level language comprises a high-level language from among the programming languages consisting of Ada, C, C++, C#, COBOL, ColdFusion, Common Lisp, Delphi, Fortran, Java, Object Pascal, SmallTalk, Visual Basic, and Visual Basic.NET.

17. The system of claim 16 wherein the high-level language comprises a statically typed high-level language selected from among the programming languages consisting of Ada, C, C++, C#, Delphi, Fortran, Java, Object Pascal, SmallTalk, Visual Basic, and Visual Basic.NET.

18. The system of claim 17 wherein the high-level language is strongly typed and comprises a high-level language selected from among the programming languages consisting of Ada, C#, Delphi, Fortran, Java, Object Pascal, and Visual Basic.NET.

19. The system of claim 17 wherein the statically typed source file is directly compiled or compiled just-in-time.

20. The system of claim 15, further comprising an integrated design environment to facilitate writing the source file.
